(19) United States
(12) Patent Application Publication
(10) Pub. No.: US 2025/0089119 A1
(43) Pub. Date: Mar. 13, 2025

(54) MANAGING ACCESS CONTROL IN SMALL DATA TRANSMISSION

(71) Applicant: GOOGLE LLC, Mountain View, CA (US)

(72) Inventor: Chih-Hsiang Wu, Taoyuan City (TW)

(21) Appl. No.: 18/727,532

(22) PCT Filed: Jan. 10, 2023
(86) PCT No.: PCT/US23/10445

§ 371 Date: Jul. 9, 2024

Related U.S. Application Data
(60) Provisional application No. 63/359,227, filed on Jul. 8, 2022.
(60) Provisional application No. 63/298,209, filed on Jan. 10, 2022.

(51) Int. Cl. H04W 76/20; H04W 48/02; H04W 74/0833; H04W 76/19; H04W 76/30

(52) U.S. Cl. CPC H04W 76/20; H04W 48/02; H04W 74/0833; H04W 76/19; H04W 76/30

(57) ABSTRACT

A UE performs a method of managing access control procedures for accessing a radio access network (RAN) during small data transmission (SDT) with the RAN. The method includes operating (702) in an inactive state with the RAN, determining (704) to make an access attempt for transmitting a non-SDT packet, and, when the UE is in SDT with the RAN, performing (710) an access control check for the access attempt and either (i) barring (718) the access attempt when the access control check does not indicate that the access attempt is allowed, or (ii) transmitting (708) a first radio resource control (RRC) message to the RAN when the access control check indicates that the access attempt is allowed.

### FIELD OF THE DISCLOSURE

This disclosure relates generally to wireless communications and, more particularly, to managing access control procedures for a user equipment (UE) and a radio access network (RAN) when the UE operates in an inactive or idle state associated with a protocol for controlling radio resources and communicates uplink and/or downlink data with the RAN.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE state that allows a UE to more quickly transition back to the RRC_CONNECTED state using RAN-level base station coordination and RAN paging procedures. In some cases, the UE in the RRC_INACTIVE state has only one, relatively small packet to transmit. For situations such as these, 3GPP is discussing a Small Data Transmission (SDT) procedure to enable the 5G NR to support data transmission for the UE operating in the RRC_INACTIVE state (i.e., without requiring that the UE transition to the RRC_CONNECTED state).

SDT is enabled on a radio bearer basis and is initiated by the UE only if less than a configured amount of uplink data awaits transmission across all radio bearers for which SDT is enabled, the downlink (DL) reference signal received power (RSRP) is above a configured threshold, and a valid SDT resource is available. An SDT procedure can be initiated by the UE with either a transmission over a random access channel (RACH), i.e., random access SDT (RA-SDT) or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (MSG3) of a 4-step random access procedure or in the payload of a message A (MSGA) of a 2-step random access procedure. The network can then schedule subsequent uplink and/or downlink transmissions using dynamic uplink grants and downlink assignments, respectively, after the completion of the random access procedure.

The CG-SDT can only be initiated with valid uplink (UL) timing alignment. The UL maintains the UL timing alignment based on a network-configured, SDT-specific timing alignment timer and DL RSRP of a configured number of highest ranked SSBs. Upon expiry of the SDT-specific timing alignment timer, the CG resources are released. Upon initiating the CG-SDT, the UE transmits an initial transmission including data on a CG occasion using a CG configuration, and the network can schedule subsequent UL transmissions using dynamic grants or on future CG resource occasions. During the CG-SDT, the DL transmissions are scheduled using dynamic assignments. The UE can initiate subsequent UL transmission only after receiving, from the network, confirmation of the initial UL transmission.

The NG-RAN supports overload and access control functionality such as RACH back off, RRC Connection Reject, RRC Connection Release, and UE-based access barring mechanisms. One unified access control framework specified in 3GPP specification 22.261 applies to all UE states (RRC_IDLE, RRC_INACTIVE, and RRC_CONNECTED) for NR. The NG-RAN broadcasts barring control information associated with Access Categories and Access Identities (in the case of network sharing, the barring control information can be set individually for each PLMN). The UE determines whether an access attempt is authorized based on the barring information broadcast for the selected PLMN, and the selected Access Category and Access Identity(ies) for the access attempt. The NG-RAN (e.g., gNB) handles access attempts with establishment causes that includes “emergency,” “mps-PriorityAccess,” and “mcs-PriorityAccess” (i.e., Emergency calls, multimedia priority service (MPS), and Mission Critical Service (MCS) subscribers, respectively) with high priority and responds with an RRC Reject message to these access attempts only in extreme network load conditions that may threaten the gNB stability.

A UE operating in the RRC_INACTIVE state can perform access control procedures. However, it is not clear how or whether the UE should perform access control when operating in the RRC_INACTIVE state and performing SDT with the RAN. Simply following access control procedures as currently defined for the RRC_INACTIVE state (e.g., access barring check or unified access control) can unnecessarily block subsequent data transmission during SDT operation.

### SUMMARY

According to certain techniques of this disclosure, a UE can disable an access control check function for at least a portion of the time that the UE is in the inactive state and communicating data with (i.e., in small data transmission (SDT) with) a RAN. In some implementations, the UE performs a first access control check after initiating SDT with the RAN (e.g., for a first packet), but then transmits subsequent uplink data (e.g., subsequent packets) to the RAN without performing additional access control checks. After the UE stops the SDT (e.g., in response to receiving an RRC release message from the RAN) and starts a non-SDT session (or another SDT session), the UE may again perform an access control check for the next uplink data (e.g., next packet). In some implementations and/or scenarios, however, the UE may transition to a connected state after the SDT (e.g., in response to receiving an RRC resume message from the RAN), and communicate additional data with the RAN while in the connected state without performing additional access control checks (e.g., until the RAN sends an RRC release message to the UE).

In some implementations, when determining to make an access control check for an SDT packet, the UE decides whether to perform an access control check for the SDT packet based on whether the UE is in SDT with the RAN and/or whether the UE has a CG configuration for SDT.

In some implementations, when determining to make an access control check for a non-SDT packet, the UE decides whether to perform an access control check for the non-SDT packet based on whether the UE is in SDT with the RAN. In other implementations, when determining to make an access control check for a non-SDT packet, the UE decides whether to perform an access control check for the non-SDT packet based on whether the UE is in SDT with the RAN and/or whether the UE has a CG configuration for SDT. In still other implementations, when determining to make an access control check for a non-SDT packet, the UE performs an access control check irrespective of whether the UE is in SDT with the RAN.

The access control management techniques described herein, in some implementations, require certain inter-protocol layer communications at the UE. For example, when an RRC layer receives a request for an access attempt from an upper (e.g., MM) layer, the RRC layer may make the determination whether to perform an access control check for the access attempt. In scenarios where the UE refrains from performing an access control check (e.g., due to the UE being in SDT with the RAN, or where the access attempt qualifies for SDT and the UE has a CG configuration for SDT), the RRC layer can send an indication to the upper layer indicating that the access attempt is allowed (despite no access control check being performed). In scenarios where the UE does perform an access control check (e.g., due to the UE not being in SDT with the RAN, or the access attempt not qualifying for SDT, or the UE not having a CG configuration for SDT), the RRC layer can send or refrain from sending an indication to the upper layer indicating that the access attempt is allowed based on the results of the access control check.

As a further example of inter-protocol layer communications at the UE, the RRC layer may indicate to an upper (e.g., MM) layer that the UE is in SDT in response to receiving an indication from a lower (e.g., MAC) layer that the RAN received an RRC resume request message from the UE. As yet another example, the RRC layer may indicate to an upper (e.g., MM) layer that SDT ends in response to the UE receiving an RRC release message from the RAN. As yet another example, the RRC layer may indicate to an upper (e.g., MM) layer whether the UE is in the inactive state with SDT configured or in the inactive state without SDT configured based on whether the UE receives from the RAN an RRC release message that configures SDT for the UE. As yet another example, the MM layer may receive a request for an access attempt from an upper (e.g., NAS) layer, determine a cause associated with the access attempt, and either request or refrain from requesting that the RRC layer perform an access control check based on whether the UE is in SDT with the RAN and/or whether the access attempt qualifies for SDT and the UE has a CG configuration for SDT. In either case, the MM layer may send the RRC layer an indication of the access attempt, along with the determined cause.

As used herein, and unless a more specific meaning is clear from the context of use, the term “data” or “data packet” can refer to signaling, control-plane information at a protocol layer of controlling radio resources (e.g., RRC), controlling mobility management (MM), or controlling session management (SM), or can refer to non-signaling, non-control-plane information at a protocol layer above the layer of the protocol for controlling radio resources (e.g., RRC), above the layer of the protocol for controlling MM, above the layer of the protocol for controlling SM, and/or above the layer of the protocol for controlling quality of service (QoS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message, for example. Further, the UE in some implementations applies SDT techniques only if the size of the data is below a certain (e.g., configured) threshold value. It is also understood that, as used herein (and unless the context of its use indicates a more specific meaning), the term “configuration” can refer to a full configuration, or to a subset of parameters of a full configuration (e.g., a “delta” or other partial configuration that can augment an existing configuration without completely replacing the existing configuration).

In one aspect, the UE performs a method of managing access control procedures for accessing a RAN during SDT. The method includes operating in an inactive state with the RAN, and determining to make an access attempt for transmitting a non-SDT packet. The method also includes, when the UE is in SDT with the RAN, performing an access control check for the access attempt, and either barring the access attempt when the access control check does not indicate that the access attempt is allowed, or transmitting a first radio resource control (RRC) message to the RAN when the access control check indicates that the access attempt is allowed.

In another aspect, a method of managing access control procedures for accessing a RAN is performed by a UE. The method includes receiving an RRC release message from the RAN, and in response to the RRC release message, transitioning from a connected state to an inactive state. The method also includes sending to an upper layer, from an RRC layer, either a first indication when the RRC release message configures SDT for the UE or a second indication when the RRC release message does not configure SDT for the UE. The first indication indicates that the UE is inactive with SDT configured, and the second indication indicates that the UE is inactive without SDT configured.

### BRIEF DESCRIPTION OF THE DRAWINGS

FIG. 1A is a block diagram of an example wireless communication system in which a radio access network (RAN) and/or a user equipment (UE) can implement the techniques of this disclosure;

FIG. 1B is a block diagram of an example base station, including a central unit (CU) and a distributed unit (DU), that can operate in the RAN of FIG. 1A;

FIG. 2A is a block diagram of an example protocol stack according to which the UE of FIG. 1A can communicate with the RAN of FIG. 1A;

FIG. 2B is a block diagram of an example protocol stack according to which the UE of FIG. 1A can communicate with a DU and a CU of a base station of FIG. 1A or 1B;

FIGS. 3A and 3B are example message sequences in which a UE, in an inactive state and in small data transmission (SDT) with a RAN, can disable an access control check function for accessing the RAN;

FIGS. 4-8 are flow diagrams of example methods for managing access control check procedures for accessing a RAN, which can be implemented by the UE of FIG. 1A;

FIGS. 9-11 are flow diagrams of example methods for managing access control check procedures for accessing a RAN, which can be implemented at an RRC layer of the UE of FIG. 1A;

FIG. 12 is a flow diagram of an example method for managing access control check procedures for accessing a RAN, which can be implemented at a mobility management (MM) layer of the UE of FIG. 1A; and

FIG. 13 is a state transition diagram depicting transitions between different states managed/operated by an MM layer of the UE of FIG. 1A.

### DETAILED DESCRIPTION OF THE DRAWINGS

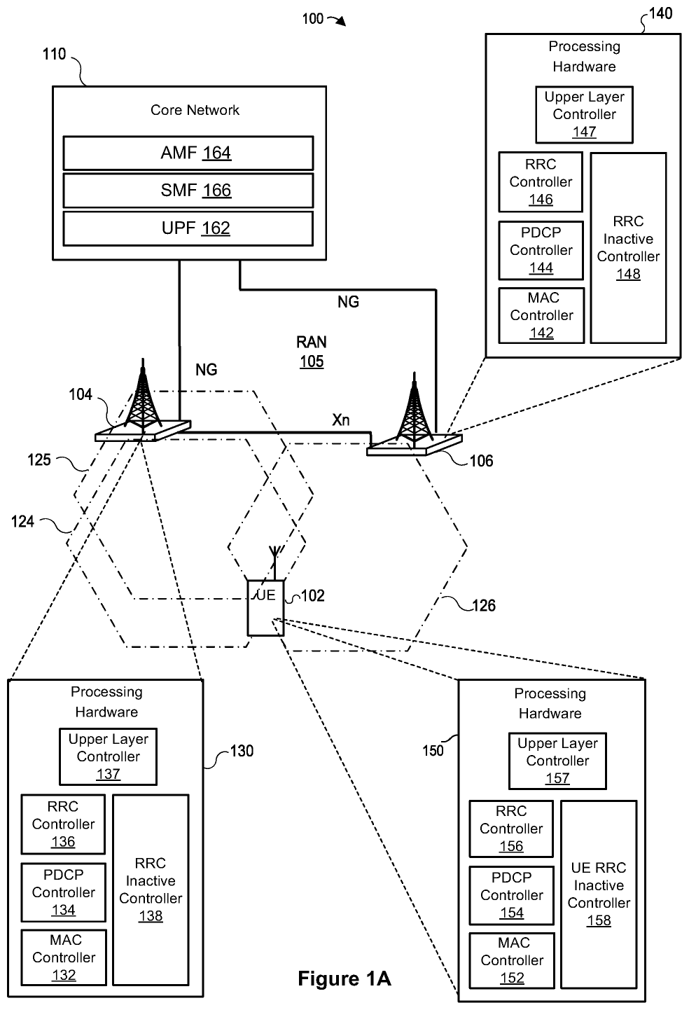

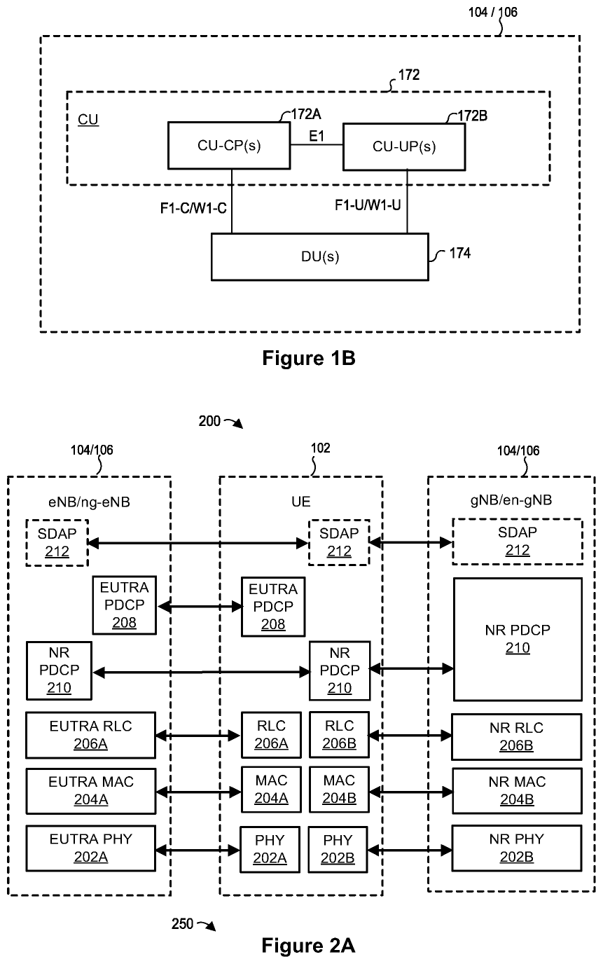

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 can cover one or more cells (e.g., cells 124 and 125), and the base station 106 can similarly cover one or more cells (e.g., cell 126). If the base station 104 is a gNB, the cells 124 and 125 are NR cells. If the base station 104 is an (ng-)eNB, the cells 124 and 125 are evolved universal terrestrial radio access (EUTRA) cells. Similarly, if the base station 106 is a gNB, the cell 126 is an NR cell, and if the base station 106 is an (ng-)eNB, the cell 126 is an EUTRA cell. The cells 124, 125, and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cells 124 and 125, and the base station 106 supports a cell 126. The cells 124, 125, and 126 can partially overlap, so that the UE 102 can select, reselect, or hand over from one of the cells 124, 125, and 126 to another. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 can implement the techniques of this disclosure for measuring a carrier frequency as instructed by the RAN 105 without interrupting data communication when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104 either via the base station 106 or with the base station 104 directly, without transitioning to the RRC_CONNECTED state. After the UE 102 determines that data is available for UL transmission in the RRC_INACTIVE or RRC_IDLE state, the UE 102 can generally secure the data, include the secured data as a security-protected packet in a first UL PDU, and transmit the first UL PDU to the RAN 105 in a second UL PDU.

As a more specific example, the UE 102 can apply one or more security functions to secure-protect the UL data packet, generate a first UL PDU that includes the security-protected UL data packet, include a UL RRC message along with the first UL PDU in a second UL PDU, and transmit the second UL PDU to the RAN 105. After receiving the second UL PDU, the RAN 105 can identify the UE 102 based on a UE identity/identifier (ID) of the UE 102 that the UE 102 included in the UL RRC message. In some implementations, the UE ID can be an inactive Radio Network Temporary Identifier (I-RNTI), resume ID, or a non-access stratum (NAS) ID. The NAS ID can be an S-Temporary Mobile Subscriber Identity (S-TMSI) or a Global Unique Temporary Identifier (GUTI), in some implementations.

In some implementations, the security function that the UE 102 applied to the UL data packet as discussed above can include an integrity protection and/or encryption function. In applying integrity protection, the UE 102 can generate a message authentication code for integrity (MAC-I) to protect integrity of the data. Thus, the UE 102 in this case generates a security-protected packet that includes the data and the MAC-I. In applying an encryption function, the UE 102 can encrypt the data to obtain an encrypted packet, so that the security-protected packet includes encrypted data. When both integrity protection and encryption are applied, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while still in the RRC_INACTIVE or RRC_IDLE state.

In some implementations, the data described above is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the MAC layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this case, the UE 102 may omit a UE ID from the UE 102 in the UL MAC PDU. In yet other implementations, the UE 102 can include the UL PDCP PDU in a UL radio link control (RLC) PDU and then include the UL RLC PDU in the UL MAC PDU. In some implementations in which the UE 102 includes the UL RRC message in the UL MAC PDU, the UE 102 generates an RRC MAC-I (e.g., resumeMAC-I field, as specified in 3GPP specification 38.331) and includes the RRC MAC-I in the UL RRC message. In other implementations, rather than generating the RRC MAC-I, the UE 102 can obtain the RRC MAC-I from the UL RRC message with an integrity key (e.g., K_{RRCint} key), an integrity protection algorithm, and parameters such as COUNT (e.g., 32-bit, 64-bit or 128-bit value), BEARER (e.g., 5-bit value), and DIRECTION (e.g., 1-bit value).

In other implementations, the data described above is a UL SDU of the NAS. The UE 102 applies the security function to the SDU and includes the secured SDU in a first UL PDU such as a UL NAS PDU, which can be associated with the NAS layer. For example, the NAS layer can be an MM or SM sublayer of 5G, evolved packet system (EPS), or 6G. Then the UE 102 can include the UL NAS PDU in a second UL PDU such as a UL RRC message. The UE 102 in these cases then transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). The UE 102 may not include an RRC MAC-I in the UL RRC message, or alternatively, include an RRC MAC-I as described above.

In some implementations, the UL RRC message described above can be a common control channel (CCCH) message, an RRC resume request message, or an RRC early data request message. The RRC resume request message can be an existing RRC resume request message (e.g., an RRCResumeRequest message, an RRCResumeRequest1 message, an RRCConnectionResumeRequest message, or an RRCConnectionResumeRequest1 message), or a new RRC resume request message that is similar to the existing RRC resume request message, but defined as a format of a RRC release or version later than that of the existing RRC resume request message. In some implementations, the UL RRC message can include a UE ID of the UE 102 as described above.

In some scenarios and implementations in which the UE ID of the UE 102 is included in the UL RRC message as described above, the base station 106 can retrieve the UE ID of the UE 102 from the UL RRC message and identify, based on the determined UE ID, the base station 104 as the destination of the data in the first UL PDU. In one implementation, the base station 106 retrieves the first UL PDU from the second UL PDU and transmits the first UL PDU to the base station 104. The base station 104 then retrieves the security-protected packet from the first UL PDU, applies security function(s) to decrypt the data and/or check the integrity protection, and transmits the data to the CN 110 (e.g., SGW 112, UPF 162, MME 114, or AMF 164) or an edge server (e.g., an edge server that can operate within the RAN 105). More specifically, the base station 104 derives security key(s) from UE context information of the UE 102. The base station 104 then retrieves the data from the security-protected packet by using the security key(s) and transmits the data to the CN 110 or edge server. In another implementation, instead of the base station 104 retrieving the security-protected packet from the first UL PDU, the base station 106 retrieves the security-protected packet from the first UL PDU. More specifically, the base station 106 can perform a retrieve UE context procedure with the base station 104 to obtain UE context information of the UE 102 from the base station 104, and then derive security key(s) from the UE context information. The base station 106 then retrieves the data from the security-protected packet by using the security key(s) and transmits the data to the CN 110 (e.g., UPF 162) or an edge server. In each of these implementations, when the security-protected packet is an encrypted packet, the base station 104 or 106 decrypts the encrypted packet to obtain the data by using the security key(s) (e.g., a (de)encryption key). If the security-protected packet is an integrity-protected packet that includes the data and the MAC-I, the base station 104 or 106 can verify whether the MAC-I is valid for the security-protected packet by using the security key(s) (e.g., an integrity key). When the base station 104 or 106 confirms that the MAC-I is valid, the base station 104 or 106 sends the data to the CN 110 or edge server. On the other hand, when the base station 104 or 106 determines the MAC-I is invalid, the base station 104 or 106 discards the security-protected packet. Further, if the security-protected packet is both encrypted and integrity-protected and therefore includes the encrypted packet along with the encrypted MAC-I, the base station 104 or 106 decrypts the encrypted packet and the encrypted MAC-I to obtain the data and the MAC-I. The base station 104 or 106 then determines whether the MAC-I is valid for the data. If the base station 104 or 106 determines that the MAC-I is valid, the base station 104 or 106 retrieves the data and forwards the data to the CN 110 or edge server. However, if the base station 104 or 106 determines that the MAC-I is invalid, the base station 104 or 106 discards the packet.

In other scenarios and implementations, the base station 104 can retrieve and use the UE ID of the UE 102 from the UL RRC message to determine that the base station 104 stores UE context information of the UE 102. Accordingly, the base station 104 retrieves the security-protected packet from the first UL PDU, retrieves the data from the security-protected packet, and sends the data to the CN 110 or edge server as described above.

Further, in some scenarios and implementations, the RAN 105 transmits data in the DL direction to the UE 102 operating in the RRC_INACTIVE or RRC_IDLE state. In one implementation, when the base station 104 determines that data is available for DL transmission to the UE 102 currently operating in the RRC_INACTIVE or RRC_IDLE state, the base station 104 can secure the data to generate a security-protected packet, generate a first DL PDU that includes the security-protected packet, and include the first DL PDU in a second DL PDU. To secure the data, the base station 104 can apply security function(s) (e.g., integrity protection and/or encryption) to the data. More particularly, similar to the manner in which the UE 102 can secure data available for UL transmission, in applying integrity protection, the base station 104 can generate a MAC-I for protecting integrity of the data available for DL transmission, so that security-protected packet includes the DL data and the MAC-I. In applying an encryption function, the base station 104 can encrypt the data to generate an encrypted packet, so that the security-protected packet includes encrypted data. Further, when both integrity protection and encryption are applied, the base station 104 can generate a MAC-I for protecting integrity of the data and encrypt the data along with the MAC-I to generate an encrypted packet and an encrypted MAC-I.

In some implementations, the base station 104 generates a first DL PDU (e.g., a DL PDCP PDU) using the security-protected packet, includes the first DL PDU in a second DL PDU (e.g., a DL MAC PDU associated with the MAC layer), and transmits the second DL PDU to the UE 102 without causing the UE 102 to transition to the RRC_CONNECTED state. In some implementations, the base station 104 includes the DL PDCP PDU in a DL RLC PDU, and further includes the DL RLC PDU in the DL MAC PDU.

In another implementation, the base station 104 transmits the first DL PDU to the base station 106, which then generates a second DL PDU (e.g., a DL MAC PDU) that includes the first DL PDU and transmits the second DL PDU to the UE 102 without causing the UE 102 to transition to the RRC_CONNECTED state. In some implementations, the base station 106 generates a DL RLC PDU that includes the first DL PDU and includes the DL RLC PDU in the second DL PDU. In yet another implementation, the base station 104 includes the first DL PDU in a DL RLC PDU and transmits the DL RLC PDU to the base station 106, which in turn generates a second DL PDU (e.g., a DL MAC PDU) that includes the DL RLC PDU and transmits the second DL PDU to the UE 102.

In some implementations, the base station 104 or 106 generates a downlink control information (DCI) and a cyclic redundancy check (CRC) scrambled with an ID of the UE 102 to transmit the second DL PDU generated by the base station 104 or 106. In some implementations, the ID of the UE 102 can be a Radio Network Temporary Identifier (RNTI), such as a cell RNTI (C-RNTI), a temporary C-RNTI, or an inactive C-RNTI. The base station 104 or 106 can transmit the DCI and scrambled CRC on a physical downlink control channel (PDCCH) to the UE 102 operating in the RRC_INACTIVE or RRC_IDLE state. In some implementations, the base station 104 or 106 may assign the ID of the UE 102 to the UE 102 in a random access response that the base station 104 or 106 transmits in a random access procedure with the UE 102 before transmitting the DCI and scrambled CRC. In other implementations, the base station 104 or 106 may assign the ID of the UE 102 to the UE 102 in an RRC message (e.g., RRC release message or an RRC reconfiguration message) that the base station 104 or 106 transmits to the UE 102 before transmitting the DCI and scrambled CRC.

After receiving the DCI and scrambled CRC on the PDCCH, the UE 102 can confirm that a physical downlink shared channel (PDSCH), including the second DL PDU, is addressed to the UE 102 according to the ID of the UE 102, the DCI, and the scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet (i.e., that includes the data and the MAC-I), the UE 102 can determine whether the MAC-I is valid. If the UE 102 confirms that the MAC-I is valid, the UE 102 retrieves the data; otherwise, the UE 102 discards the data. If the security-protected packet is both encrypted and integrity-protected (i.e., includes encrypted data and an encrypted MAC-I), the UE 102 can decrypt both the encrypted packet and encrypted MAC-I to obtain the data and the MAC-I. The UE 102 then can verify whether the MAC-I is valid for the data. If the UE 102 confirms that the MAC-I is valid, the UE 102 retrieves and processes the data; otherwise, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a MAC controller 132 configured to perform a random access procedure with one or more user devices (e.g., UE 102), receive UL MAC PDUs from the one or more user devices, and transmit DL MAC PDUs to the one or more user devices. The processing hardware 130 can also include a PDCP controller 134 configured to transmit and/or receive PDCP PDUs in accordance with the manner in which the base station 104 can transmit DL data and/or receive UL data, respectively. The processing hardware 130 can further include an RRC controller 136 to implement procedures and messaging at the RRC sublayer of the protocol communication stack. The processing hardware 130 can further include an upper layer controller 137 to implement procedures and messaging at one or more upper layers, such as MM and/or NAS layers of the protocol communication stack. The processing hardware 130 in an example implementation includes an RRC inactive controller 138 configured to manage UL and/or DL communications with the one or more UEs operating in the RRC_INACTIVE or RRC_IDLE state. Alternatively, some or all of the functionality of the RRC inactive controller 138 may be implemented by other controllers, such as the controllers 134, 136, and/or 137. In addition to supporting messaging external to the base station 104, the controllers 132, 134, 136, 137, and/or 138 can exchange internal, “inter-protocol layer” (IPL) messages with each other. The base station 106 can include processing hardware 140 that is similar to processing hardware 130. In particular, components 142, 144, 146, 147, and 148 can be similar to the components 132, 134, 136, 137, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage UL and/or DL communications when the UE 102 operates in the RRC_INACTIVE or RRC_IDLE state. The processing hardware 150 in an example implementation includes a MAC controller 152 configured to perform a random access procedure with base station 104 or 106, transmit UL MAC PDUs to the base station 104 or 106, and receive DL MAC PDUs from the base station 104 or 106. The processing hardware 150 can also include a PDCP controller 154 configured to transmit and/or receive PDCP PDUs in accordance with the manner in which the UE 102 can transmit UL data and/or receive DL direction. The processing hardware 150 can further include an RRC controller 156 to implement procedures and messaging at the RRC sublayer of the protocol communication stack. The processing hardware 150 can further include an upper layer controller 157 to implement procedures and messaging at one or more upper layers, such as MM and/or NAS layers of the protocol communication stack.

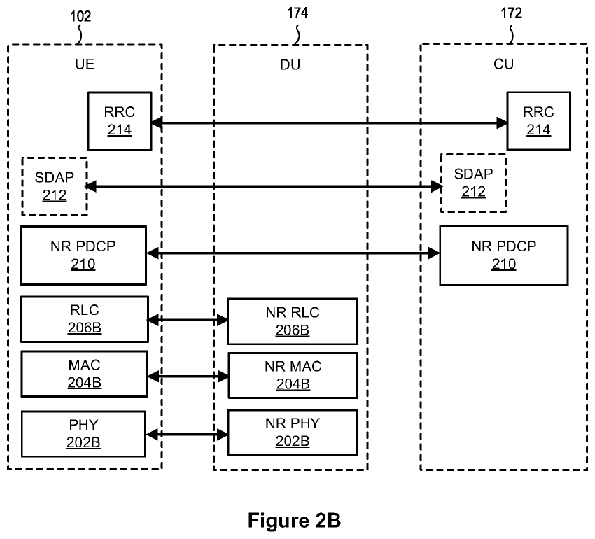

In addition to supporting messaging external to the UE 102, the controllers 152, 154, 156, 157, and/or 158 can exchange internal IPL messages with each other. For example, as discussed further below, the RRC layer controller 156 can send the upper layer controller 157 an IPL message indicating that an access attempt is allowed for a packet, that an access attempt is barred for a packet, and so on. In some implementations where the upper layer controller 157 is an MM layer controller, the MM layer controller 157 implements a state machine while in the 5GMM-CONNECTED state, with different states corresponding to different RRC layer states (e.g., RRC_INACTIVE or RRC_CONNECTED as indicated by the RRC layer controller 156) and/or different SDT statuses (e.g., SDT configured but inactive, SDT configured and active, or no SDT), and specifies actions to be executed upon state transitions. As used herein, “receive from,” “communicate with,” “send to,” or “indicate to” can refer to the exchange of information between layers of a wireless communication protocol stack (e.g., via one or more IPL messages), such as the protocol stacks discussed below with reference to FIGS. 2A and 2B, with the communicating/sending layer being the information source and the receiving layer being the information destination.

For simplicity, the discussion that follows at times describes various actions as being performed by particular layers rather than their respective controllers. In each such instance, it is understood that the respective controller performs the indicated action(s). For example, while the discussion below refers to various layers sending or receiving IPL messages to exchange information between layers, it is understood that it is the respective controllers that send or receive those IPL messages. More generally, references to performing an action (e.g., making a determination) “at” a particular layer are understood to mean that the respective controller performs that action.

FIG. 1B depicts an example distributed or disaggregated implementation of one or both of the base stations 104, 106. In this implementation, each of the base station 104 and/or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller (e.g., PDCP controller 134, 144), an RRC controller (e.g., RRC controller 136, 146), and/or an RRC inactive controller (e.g., RRC inactive controller 138, 148). In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit data packets (e.g., SDAP PDUs or IP packets).

The CU-CP 172A can be connected to multiple CU-UPs 172B through the E1 interface. The CU-CP 172A selects the appropriate CU-UP 172B for the requested services for the UE 102. In some implementations, a single CU-UP 172B can be connected to multiple CU-CPs 172A through the E1 interface. If the CU-CP 172A and DU(s) 174 belong to a gNB, the CU-CP 172A can be connected to one or more DU 174s through an F1-C interface and/or an F1-U interface. If the CU-CP 172A and DU(s) 174 belong to an ng-eNB, the CU-CP 172A can be connected to DU(s) 174 through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

FIG. 2A illustrates, in a simplified manner, an example protocol stack 200 according to which the UE 102 can communicate with an eNB/ng-eNB or a gNB (e.g., one or both of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to the SDAP sublayer 212 or an RRC sublayer (not shown in FIG. 2A). The UE 102, in some implementations, supports both the EUTRA and the NR stack as shown in FIG. 2A, to support handover between EUTRA and NR base stations and/or to support dual connectivity (DC) over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) to the RRC sublayer (not shown in FIG. 2A) to exchange RRC messages or NAS messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, IP packets, or Ethernet packets.

Thus, it is possible to functionally split the radio protocol stack, as shown by the radio protocol stack 250 in FIG. 2B. The CU at one or both of the base stations 104, 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

As used herein, the term “upper layer” is a relative term indicating that a given layer is above a reference layer or layers, and “lower layer” is a relative term indicating that a given layer is below a reference layer or layers. Thus, for example, the MM layer 214 is an upper layer relative to the RRC layer 210, while each of the layers 202, 204, and 206 is a lower layer relative to the RRC layer 210. Wherever the term “upper layer” is used herein without indicating the reference layer, the reference layer is above the RRC layer (e.g., above RRC layer 210).

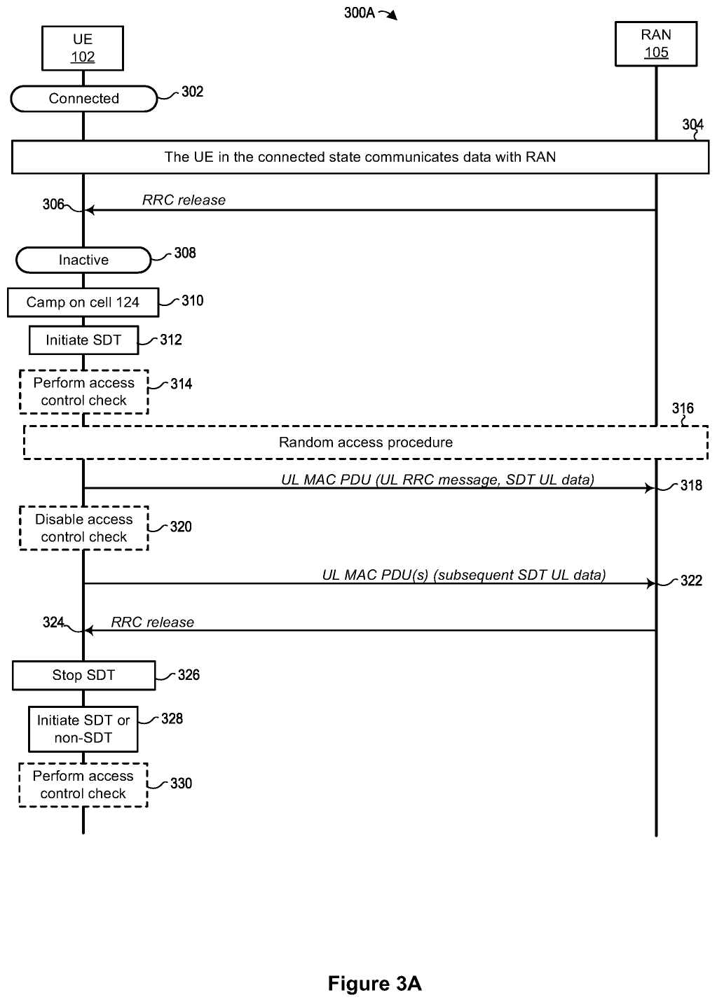

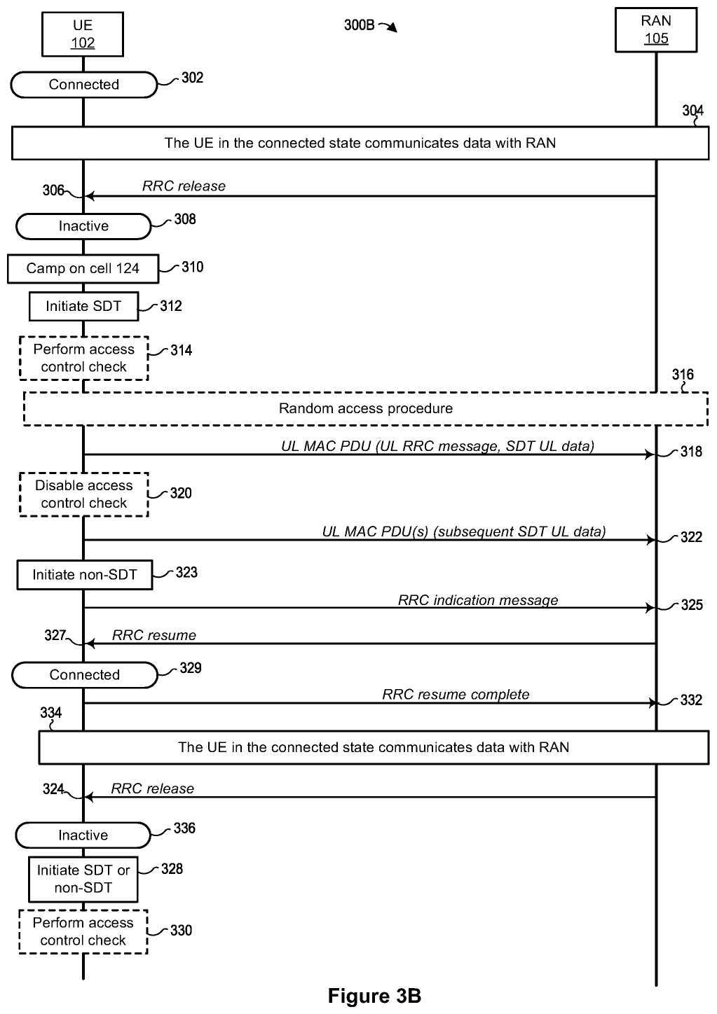

Next, several example scenarios that involve various components of FIG. 1A and relate to managing access control while the UE 102 is in an inactive or idle state with SDT are discussed with reference to FIGS. 3A and 3B. Generally, events in FIGS. 3A and 3B that can be the same are labeled with the same reference numbers. To simplify the following description, the “inactive state” is used to represent either the inactive (e.g., RRC_INACTIVE) or idle (e.g., RRC_IDLE) state, unless otherwise noted.

Referring first to FIG. 3A, in a scenario 300A, the UE 102 initially operates 302 in a connected (e.g., RRC_CONNECTED) state and communicates 304 data with the RAN 105 (e.g., base station 104 and/or base station 106), e.g., via one or more radio bearers (RBs). In some implementations, the UE 102 in the connected state communicates 304 control-plane (CP) data with the RAN 105 via one or more signaling RBs (SRBs). In such implementations, the CP data includes RRC PDUs that includes RRC messages, NAS messages, IP packets, Ethernet packets, and/or application packets. In other implementations, the UE 102 in the connected state communicates 304 CP data and/or user-plane (UP) data with the RAN 105 via one or more data RBs (DRBs). The UP data in some example scenarios includes IP packets, Ethernet packets, and/or application packets.

While the UE 102 operates 302 in the connected state, the RAN 105 transmits to the UE 102 a plurality of configuration parameters for communicating with the UE 102 at event 304. The UE 102 communicates 304 with the RAN 105 using the configuration parameters. In some implementations, the configuration parameters include configuration parameters in a CellGroupConfig IE defined in 3GPP specification 38.331. While the UE 102 operates 302 in the connected state, the RAN 105 can transmit to the UE 102 one or more measurement configurations (e.g., MeasConfig IE). The measurement configuration(s) configures one or carrier frequencies and include reporting configuration(s). The UE 102 in the connected state performs measurements on the one or more carrier frequencies and obtains measurement result(s) from the measurements. In some implementations, the measurement result(s) can include or indicate reference signal received quality (RSRP), reference signal received quality (RSRQ), and/or signal to interference and noise ratio (SINR) value(s) for the one or more carrier frequencies or for one or more cells operated on the one or more carrier frequencies. In some implementations, the RAN 105 can include measurement gap configuration(s) in the measurement configuration(s) so that the UE 102 can measure a particular carrier frequency using gap(s) configured in the measurement gap configuration(s). If the UE 102 detects that a reporting condition in the reporting configuration(s) is met, the UE 102 can transmit a measurement report including the measurement result(s) to the RAN 105.

After a (first) certain period of data inactivity, the RAN 105 can determine that neither the RAN 105 nor the UE 102 has transmitted any data in the downlink direction or the uplink direction, respectively, during the certain period. In response to the determination, the RAN 105 can transmit 306 a first DL RRC message to the UE 102 to instruct the UE 102 to transition 308 to the inactive state. In some implementations, the first DL RRC message can be a first RRC release message (e.g., RRCRelease message or RRCConnectionRelease message). In some implementations, the RAN 105 can assign an I-RNTI or a resume ID to the UE 102 and include the assigned value in the first RRC release message. In addition, the RAN 105 can include a security configuration (e.g., NextHopChainCount IE) in the first RRC release message. The UE 102 applies the security configuration to obtain one or more security keys (e.g., encryption key and/or integrity key). The UE 102 uses the security key(s) to perform one or more security functions with respect to UL data and/or DL data in an SDT session (e.g., data exchanged between event 316 and 324, such as events 318, 322, and 324, and/or other data exchanged during events not shown in FIG. 3A).

In some implementations, the RAN 105 includes an SDT configuration in the first RRC release message to enable SDT for the UE 102 (i.e., to enable the UE 102 to perform SDT upon receiving the first RRC release message). The RAN 105 in some implementations can indicate RBs as SDT RB(s) (i.e., the RB(s) are suitable or configured for SDT) or non-SDT RB(s) (i.e., the RB(s) are unsuitable or not configured for SDT). For example, the RAN 105 can include at event 306 an SDT indication in the first RRC release message to indicate that a first SRB is an SDT RB. In cases where the RAN 105 does not include an SDT indication for a second SRB in the first RRC release message, the UE 102 determines that the second SRB is a non-SDT RB by default. Alternatively, the RAN 105 can include a non-SDT indication in the first RRC release message to indicate that the second SRB is a non-SDT RB. In another similar example, the RAN 105 can include an SDT indication in the first RRC release message to indicate that a first DRB is an SDT RB. In cases that the RAN 105 does not include an SDT indication for a second DRB in the first RRC release message, the UE 102 determines that the second DRB is a non-SDT DRB by default. Alternatively, the RAN 105 can include a non-SDT indication in the first RRC release message to indicate that the second DRB is a non-SDT RB. In other implementations, particular RB(s) (e.g., SRB0, SRB1, and/or SRB2) can be considered SDT RB(s) by default, even though the RAN 105 does not indicate that the particular RB(s) are SDT RB(s) in the first RRC release message. In such implementations, the UE 102 determines that the particular RB(s) are SDT RB(s) as a default, even though the UE 102 does not receive from the RAN 105 indication(s) that identify the particular RB(s) as SDT RB(s).

The SDT configuration can include one or more SDT initiation criteria configurations, a configured grant (CG) configuration, multiple CG configurations, a configuration of HARQ retransmission with the CG configuration(s), a subsequent SDT configuration, a repetition configuration, a PDCCH configuration, a PUCCH configuration, and/or PUSCH configuration. The SDT configuration can also include a UL bandwidth part (BWP) configuration and/or a DL BWP configuration. Some of the configurations described above in the SDT configuration can be CG-SDT specific configurations, RA-SDT specific configurations or common configurations for both CG-SDT and RA-SDT.

For example, the SDT initiation criteria configuration(s) can include a signal strength threshold (e.g., RSRP threshold, RSRQ threshold, SINR threshold, and/or other suitable metrics), a maximum data volume size, a maximum packet size, and/or a maximum number of packets for an SDT session. In accordance with the SDT initiation criteria configuration(s), in some implementations, the UE 102 can perform SDT (i.e., initial SDT and/or subsequent SDT) only if a signal strength obtained by the UE 102 from measurements is above the signal strength threshold specified by the SDT initiation criteria configuration(s). In some implementations, the maximum data volume size specifies a maximum number of octets for all SDT RB(s) (i.e., the RB(s) suitable or configured for SDT) that the UE 102 can transmit in an SDT session. In some implementations, the maximum packet size specifies a maximum number of octets that the UE 102 can transmit in a single SDT (i.e., an uplink MAC PDU). In other implementations, the maximum packet size specifies a maximum number of octets for a single packet that the UE 102 can transmit. The single packet can be an application data packet (e.g., IP packet or Ethernet packet), an SDAP PDU, a NAS PDU, an RRC PDU, a PDCP SDU, a PDCP PDU, or an RLC PDU.

As another example, each, or at least some, of the CG configurations(s) can include a time domain resources allocation configuration, a frequency domain resources allocation configuration, a hybrid automatic repeat request (HARQ) configuration, one or more SDT initiation criteria configurations, a repetition configuration, a PDCCH configuration, a PUCCH configuration, a PUSCH configuration, a configuration of HARQ retransmission, a frequency hopping configuration, and/or a physical layer acknowledgement configuration, which are specific for SDT using radio resources configured by the CG configuration(s). In other implementations, each, or at least some, of the CG configuration(s) can include configuration parameters similar to configuration parameters included in a ConfiguredGrantConfiguration IE specified in 3GPP specification 38.331.

In some implementations, the subsequent SDT configuration can configure the number of subsequent data packets, the number of bytes for subsequent data or the number of CG radio resources that the UE 102 is allowed to use or transmit for subsequent UL data in an SDT session. In some implementations where the RAN 105 does not provide the UE 102 with the subsequent SDT configuration, the UE 102 is consequently disabled from transmitting subsequent UL data in an SDT session. Alternatively, the UE 102 is allowed to transmit subsequent UL data without any restriction, in cases where the RAN 105 does not provide the UE 102 with the subsequent SDT configuration. In some implementations, the repetition configuration enables or configures the UE 102 to transmit repetitions of a UL transmission (e.g., a PUSCH transmission or a UL MAC PDU) in an SDT session. In cases where the RAN 105 does not provide the UE 102 with the repetition configuration, the UE 102 is consequently disabled from transmitting repetitions for a UL transmission in an SDT session.

In response to or upon receiving the first RRC release message at event 306, the UE 102 transitions 308 to the inactive state and retains a portion or all of the configuration parameters that the UE 102 applied to communicate with the RAN 105 while operating in the connected state. The UE 102 also retains the measurement configuration(s) upon transitioning to the inactive state. In some implementations in which either the base station 104 or base station 106 of the RAN 105 is a distributed or disaggregated base station including a CU 172 and DU 174 as described in FIG. 1B, after the UE 102 transitions 308 to the inactive state, the UE 102 can perform one or more RAN notification area (RNA) updates with the CU 172 via the DU 174 without state transitions (e.g., without transitioning from the inactive state back to the connected state).

After the UE 102 transitions 308 to the inactive state, the UE 102 camps 310 on (e.g., selects or reselects) cell 124. At a later time, the UE 102 in the inactive state initiates 312 SDT (e.g., in accordance with the SDT configuration received in event 306) to transmit UL data to or receive DL data from the RAN 105. Event 312 can include initiating an access attempt for an SDT packet. In cases of transmitting, e.g., at event 314, UL data while the UE 102 is in the inactive state, the SDT is referred to as mobile originating (MO) SDT. In cases of receiving DL data while the UE 102 is in the inactive state, the SDT is referred to as mobile terminating (MT) SDT (i.e., small data reception from the viewpoint of the UE 102). In such cases, the UE 102 at event 312 receives from the RAN 105 a paging message, which includes a UE ID of the UE 102 and an SDT indication. The UE ID can be an I-RNTI, a resume ID, or a NAS ID (e.g., S-TMSI or 5G-S-TMSI). In response to the paging message (i.e., the UE ID and the SDT indication), the UE 102 initiates SDT.

In some implementations, the UE 102 can initiate SDT only if a signal strength obtained by the UE 102 from measuring a serving carrier frequency of the cell 124 exceeds a signal strength threshold specified by the SDT initiation criteria configuration(s). If the signal strength exceeds the signal strength threshold, the UE 102 can begin performing SDT via the cell 124.

In some implementations, the UE 102 can determine whether the UL data for transmission during SDT qualifies for transmission in the inactive state in view of one or more factors, such as whether the UL data is an IMS packet, whether the UL data is associated with a radio bearer (e.g., DRB or SRB) not suitable or configured for SDT, whether the UL data is an NAS message for initiating a particular NAS procedure, the size of the data, and/or one or more other factors. If the UE 102 determines that the UL data does not qualify for transmission in the inactive state, the UE 102 can perform an RRC procedure (e.g., RRC connection establishment procedure or RRC resume procedure) to transition to the connected state.

After or in response to initiating an access attempt for SDT at event 312, the UE 102 can perform 314 an access control check (e.g., access barring check or unified access control (UAC) check) for the access attempt, based on barring information broadcast by the RAN 105 via the cell 124, an access category, and/or an access identity. If the UE 102 determines that the access attempt for SDT is allowed as a result of the access control check, the UE 102 in the inactive state transmits 318 an initial UL MAC PDU to RAN 105 on the cell 124. In cases of MO SDT, the UE 102 can include UL data in the initial UL MAC PDU, and the RAN 105 retrieves the UL data from the initial UL MAC PDU. In cases of MT SDT, the UE 102 does not include UL data in the initial UL MAC PDU. The UL RRC message can be a CCCH message, an RRC resume request message, or an RRC early data request message, as described above in reference to FIG. 1A. For MO SDT, the UL RRC message can include a cause value (e.g., “mo-data”) which can be a field or information element (IE) (e.g., resumeCause or ResumeCause). For MT SDT, the UL RRC message can include an SDT indication, which can be a field or IE (e.g., resumeCause or ResumeCause). In some implementations, the barring information can be UAC-BarringInfoSet IE as described in 3GPP specification 38.331. If the UE 102 determines that the access attempt for SDT is not allowed as a result of the access control check, the UE 102 in the inactive state refrains from transmitting the UL RRC message and/or the UL data.

In some implementations, to transmit the initial UL MAC PDU at event 318, the UE 102 in the inactive state performs 316 a random access procedure with the RAN 105 on the cell 124, i.e., RA-SDT, where the event 316 may include the transmission of event 318. For example, the random access procedure can be a four-step random access procedure or a two-step random access procedure. In the case of the four-step random access procedure, the UE 102 transmits a random access preamble to the RAN 105, the RAN 105 in response transmits to the UE 102 a random access response (RAR) including an uplink grant, and the UE 102 transmits 318 the UL MAC PDU as a message 3 of the four-step random access procedure in accordance with the uplink grant. The RAN 105 receives 318 the UL MAC PDU in accordance with the uplink grant in the RAR. In the case of the two-step random access procedure, the UE 102 transmits 318 to the RAN 105 a message A including a random access preamble and the UL MAC PDU in accordance with two-step random access configuration parameters. The UE 102 can receive the two-step random access configuration parameters in system information broadcast by the RAN 105 on cell 124 before transmitting 318 the UL MAC PDU. The RAN 105 receives 318 the UL MAC PDU in accordance with the two-step random access configuration parameters. After the RAN 105 receives 318 the UL MAC PDU in the random access procedure, the RAN 105 can transmit a contention resolution (e.g., a MAC control element in a message 4 of the four-step random access procedure or in a message B of the two-step random access procedure) to the UE 102 to complete the random access procedure. In further implementations, the UE 102 can transmit 318 the UL MAC PDU on radio resources configured in CG configuration(s) on the cell 124 to the RAN 105, i.e., CG-SDT. The RAN 105 can include the CG configuration to the UE 102 in the first RRC release message. Thus, the RAN 105 receives 318 the UL MAC PDU on the radio resources. In some implementations, upon receiving the contention resolution, the UE 102 determines that the RAN 105 received the UL MAC PDU or the RRC resume request message and determines that the SDT session has been initiated successfully.

In some implementations, the UE 102 can omit, skip, or refrain from performing an access control check for the access attempt 312 in the case of CG-SDT. If the UE 102 receives or has a CG configuration, the UE 102 can omit, skip, or refrain from performing an access control check for an access attempt for SDT (e.g., the access attempt for SDT initiated at event 312) and transmits 318 the UL MAC PDU to the RAN 105 on the cell 124.

Otherwise, if the UE 102 does not receive or have a CG configuration, the UE 102 performs an access control check for an access attempt for SDT (e.g., the access attempt for SDT initiated at event 312) and determines whether the UE 102 is allowed to perform a random access procedure, as described above. In some implementations, the RAN 105 can configure a CG configuration specific to a logical channel, a radio bearer, or a type of UL data. If the UE 102 determines that the UL data qualifies to be transmitted on radio resources configured in the CG configuration, the UE 102 can omit, skip, or refrain from performing an access control check for an access attempt for SDT (e.g., the access attempt for SDT initiated at event 312). Otherwise, if the UE 102 does not receive or have a CG configuration or the UE 102 determines that the UL data does not qualify to be transmitted on radio resources configured in the CG configuration, the UE 102 performs an access control check for an access attempt for SDT (e.g., the access attempt for SDT initiated at event 312) and determines whether the UE 102 is allowed to perform a random access procedure, as described above.

After receiving 318 the UL RRC message and/or the UL data, the RAN 105 refrains from transitioning the UE 102 to a connected state and communicates 322 data (i.e., subsequent UL data as shown in FIG. 3A, and/or DL data) with the UE 102 operating in the inactive state. However, the UE 102 disables 320 an access control check function of the UE 102 (i.e., disables/prevents access control checks by the UE 102) for transmission of subsequent UL data. In some implementations, the UE 102 disables 320 an access control check if the UE 102 determines that the UL MAC PDU 318 is successfully transmitted to the RAN 105. In the case of RA-SDT, the UE 102 can determine that the UL MAC PDU sent at event 318 is successfully transmitted to the RAN 105 if the UE 102 receives the contention resolution for the UL MAC PDU. In other implementations and/or scenarios, event 320 may occur before event 314, 316, and/or 318. In each case, however, the access control check function is disabled for at least a portion of the time that the UE 102 is in SDT with the RAN 105 and transmitting UL data to the RAN 105 (i.e., at least a portion of the time between events 312 and 326).

In some implementations, the data at event 318 or 322 can include at least one data packet for an application or a protocol layer, such as an MM layer (e.g., 5G MM), an SM layer (e.g., 5G SM), an LTE positioning protocol (LPP) layer, or a secure user-plane location (SUPL) protocol layer. The data packet can be an IP packet, an Ethernet packet, an application packet. In other implementations, the data packet can be a PDCP PDU that includes an RRC PDU, an MM PDU, an SM PDU, an LPP PDU, an IP packet, an Ethernet packet, or an application packet. In yet other implementations, the data packet can be an RRC PDU including a NAS PDU, such that the NAD PDU includes an IP packet, an Ethernet packet, or an application packet. More specifically, the UE 102 can transmit 322 to the RAN 105 one or more UL MAC PDUs, and/or the RAN 105 can transmit 322 to the UE 102 one or more DL MAC PDUs, where each of the UL MAC PDU(s) and/or DL MAC PDU(s) can include a particular data packet or a particular segment of a data packet. In some implementations, the UE 102 can transmit 322 each, or at least some, of the UL MAC PDU(s) on radio resources configured in the CG configuration(s) described above. In other implementations, the RAN 105 can transmit to the UE 102 one or more DCIs for the UE 102 on PDCCH(s), where each of the DCI(s) includes an uplink grant. In such cases, the UE 102 transmits 322 each, or at least some, of the UL MAC PDU(s) on radio resources assigned by the uplink grant(s). Similarly, the RAN 105 can transmit one or more DCIs for the UE 102 on PDCCH(s), where each of the DCI(s) includes a downlink assignment. In such cases, the UE 102 receives 322 the DL MAC PDU(s) on radio resources assigned by the downlink assignment(s).

In some implementations, the RAN 105 can transmit the DCI(s) on the PDCCH(s) via the cell 124 using a search space for SDT (i.e., SDT-specific search space). The RAN 105 can include an SDT-specific search space configuration specifying/configuring the SDT-specific search space in the first DL RRC message. Alternatively, the RAN 105 can broadcast a SIB including the SDT-specific search space configuration via the cell 124 and/or other cell(s) (e.g., cell 125 and/or cell 126). In such cases, the UE 102 can use the SDT-specific search space to receive the DCI(s) on the PDCCH(s) via the cell 124. In cases where the RAN 105 does not provide an SDT-specific search space configuration to the UE 102, the RAN 105 can transmit the DCI(s) on the PDCCH(s) using a common search space. In such cases, the UE 102 can use the common search space to receive the DCI(s) on the PDCCH(s) via the cell 124. The RAN 105 can broadcast, via the cell 124, a SIB including a common search space configuration specifying/configuring the common search space.

Generally, when the RAN 105 receives all segments of a data packet from the UE 102, the RAN 105 assembles the segments to obtain the data packet and can process the data packet or send the data packet to the CN 110. In some implementations, the UE 102 at event 322 can transmit a plurality of segments of a particular data packet for an application or a protocol layer to the RAN 105, until all segments of the data packet are transmitted to the RAN 105. Similarly, when the UE 102 receives 322 all segments of a data packet from the RAN 105, the UE 102 assembles the segments to obtain the data packet.

After a (second) certain period of data inactivity for the UE 102, the RAN 105 can determine that neither the RAN 105 nor the UE 102 has transmitted any data in the downlink direction or the uplink direction after events 318 and/or 322, respectively, during the (second) certain period. In response to the determination, the RAN 105 can transmit 324 a second DL RRC message (e.g., a second RRC release message) to the UE 102, similar to event 306. In some implementations, the UE 102 can receive a DCI configuring a downlink assignment on a PDCCH from the RAN 105, and receive 324 the second DL RRC message on radio resources configured in the downlink assignment. In some implementations, the UE 102 can receive the DCI on the PDCCH via the cell 124 using the SDT-specific search space configuration. In cases where the UE 102 does not receive an SDT-specific search space configuration from the RAN 105, the UE 102 can receive the DCI on the PDCCH via the cell 124 using the common search space configuration.

In response to the second DL RRC message, the UE 102 remains in the inactive state and stops 326 SDT (i.e., the SDT session ends). In some implementations, the RAN 105 can assign an I-RNTI or a resume ID to the UE 102 and include the assigned value in the second RRC release message. In addition, the RAN 105 can include a security configuration (e.g., NextHopChainCount IE) in the second RRC release message. The UE 102 can apply the security configuration to obtain one or more security keys (e.g., encryption key and/or integrity key) and use the security key(s) to perform one or more security functions to UL data and/or DL data communicated with the RAN 105 in the next SDT session. In some implementations, the first and second periods of data inactivity are the same time period. In other implementations, the first and second periods of data inactivity are different.

In some alternative implementations, the second DL RRC message can be an RRC reject message instead of an RRC release message. In such cases, the RAN 105 in one implementation may apply the security function (e.g., integrity protection) to the RRC reject message. Alternatively, the RAN 105 does not apply the security function(s) to the RRC reject message.

In some implementations, the RAN 105 can indicate that the UE 102 is to use the (current) SDT configuration (i.e., received at event 306) in the second DL RRC message. In other implementations, the RAN 105 can include a second SDT configuration in the second DL RRC message to update the current SDT configuration. The second SDT configuration can include one or more configurations similar to the current SDT configuration described above.

In some implementations, the RAN 105 can determine the first and second periods (i.e., data inactivity time thresholds) based on the RB(s) with which the UL data and/or DL data at event 304 and event 318 or 322, respectively, are associated. For example, in the case where the UL data and/or DL data at event 304 and event 318 or 322, respectively, are associated with a first RB, the RAN 105 can set the first and second periods to a first time period. In the case where the UL data and/or DL data at event 304 and event 318 or 322, respectively, are associated with a second RB, the RAN 105 can set the first and second periods to a second time period. In the case where the UL data and/or DL data at event 304 and event 318 or 322, respectively, are associated with a third RB, the RAN 105 can set the first, second, and/or third periods to a third time period. In other implementations, the RAN 105 can determine the first and second periods irrespective of RB(s). For example, the RAN 105 can determine the first and second periods to be the same time period. In yet other implementations, the RAN 105 can determine the first and second periods to be different time periods. For example, the RAN 105 can set the first period to be longer than the second period.

After stopping 326 the SDT, the UE 102 can initiate 328 SDT or non-SDT. Event 328 includes initiating a second access attempt for transmitting UL data (e.g., a packet). In response to the initiating an access attempt at event 328, the UE 102 can perform 330 a second access control check for the second access attempt, similar to the event 314. In accordance with a result of the second access control check, the UE 102 can transmit the UL data as described above.

Turning to FIG. 3B, a scenario 300B is similar to the scenario 300A, with differences described below. During the SDT session, the UE 102 initiates 323 non-SDT to transmit UL data (i.e., non-SDT UL data). In response to the initiation at event 323, the UE 102 transmits 325 to the RAN 105 via the cell 124 an RRC indication message to request transitioning to the connected state, thereby indicating that the connected state is preferred, and/or that non-SDT data available. In response to or after receiving 325 the RRC indication message, the RAN 105 transmits 327 an RRC resume message (e.g., RRCResume message) via the cell 124 to the UE 102 to transition the UE 102 to a connected state (e.g., RRC_CONNECTED). In response, the UE transitions 329 to the connected state and transmits 332 an RRC resume complete message (e.g., RRCResumeComplete message) to the RAN 105 via the cell 124. After receiving 327 the RRC resume message or transmitting 332 the RRC resume complete message, the UE 102 in the connected state can communicate 334 UL data and/or DL data with the RAN 105. The UL data can include the non-SDT UL data triggering the initiation at event 323. In some implementations, UL data of event 334 includes non-SDT UL data (i.e., data associated with RB(s) not configured for SDT) and/or SDT UL data (i.e., data associated RB(s) configured for SDT). Similarly, DL data of event 334 can include non-SDT DL data (i.e., data associated with RB(s) not configured for SDT) and/or SDT DL data (i.e., data associated with RB(s) configured for SDT).

In other implementations, the UE 102 can set the threshold to a preconfigured, predetermined, or default value. In some implementations the RRC indication message can be an RRC resume request message as described above. In some implementations, the RRC indication message can be a UEAssistanceInformation message. In other implementations, the RRC indication message can be a new UL RRC message, e.g., included in a UL-DCCH-Message defined in 3GPP specification 38.331 release 17 version. In some implementations, the RRC indication message includes an indication field/IE indicating the connected state is preferred or requested or SDT is no longer suitable. For example, the indication field/IE can be defined in the 3GPP specification 38.331 release 17 version. In other implementations, the RRC indication message includes a cause value indicating what caused the UE 102 to prefer the connected state or caused SDT to no longer be suitable. For example, the cause value can indicate that the radio condition(s) is/are met. In another example, the cause value can be as defined in the 3GPP specification 38.331 release 17 version. In some implementations, the UE 102 can include, in the RRC indication message, measurement result(s) indicating that signal strength/quality of the cell 124 and/or signal strength/quality of the cell 125 and/or the cell 126. The UE 102 can apply the security function(s) to the RRC indication message to secure-protect the RRC indication message as described for protecting the UL data packet.

After a (third) certain period of data inactivity for the UE 102, the RAN 105 can determine that neither the RAN 105 nor the UE 102 has transmitted any data in the downlink direction or the uplink direction after event 334, respectively, during the (third) certain period. In response to the determination, the RAN 105 can transmit 324 the second DL RRC message (e.g., a second RRC release message) to the UE 102, similar to event 306. In response to the second RRC release, the UE 102 transitions 336 to the inactive state, similar to the event 308.

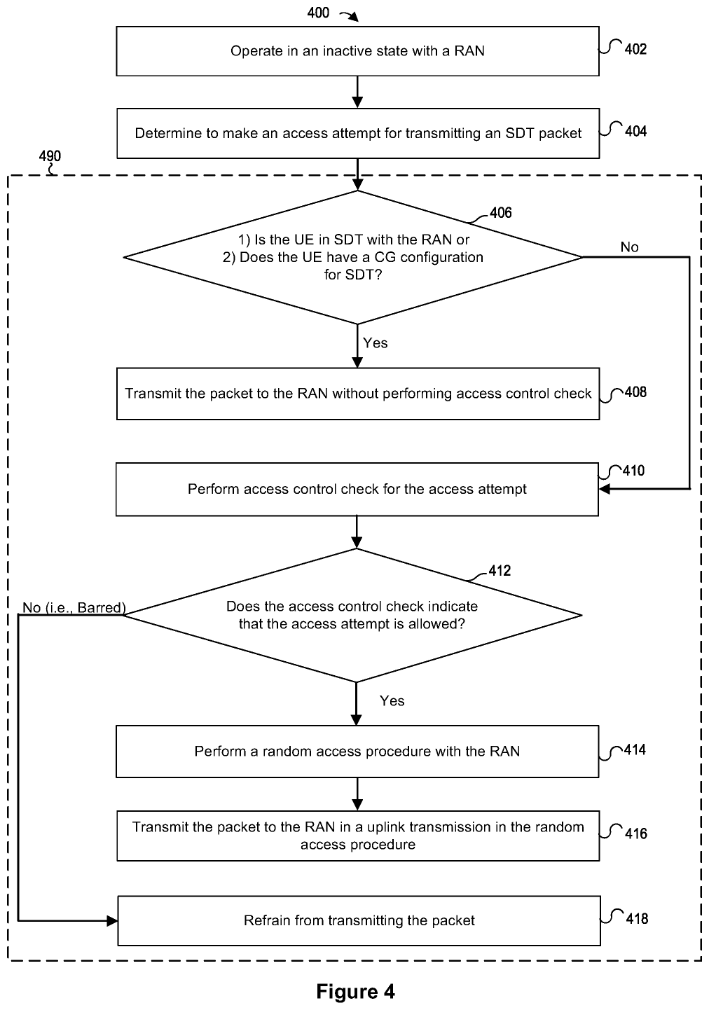

FIGS. 4-13 are flow diagrams depicting example methods that a UE (e.g., the UE 102) can implement to manage an access control check (e.g., access barring check) for SDT.

Turning first to FIG. 4, a UE (e.g., the UE 102) can implement an example method 400 to determine whether to perform an access control check for an access attempt, while operating in the inactive state.

The method 400 begins at block 402, where the UE operates in an inactive state with a RAN (e.g., event 308). At block 404, the UE determines to make an access attempt for transmitting an SDT packet (i.e., a packet for SDT) (e.g., event 312). At block 406, the UE determines whether 1) the UE is in SDT with the RAN or 2) the UE has a CG configuration for SDT. If the UE determines that 1) the UE is in SDT with the RAN or 2) the UE has a CG configuration for SDT (i.e., based on or in response to this determination, and if either one or both conditions is/are satisfied), the flow proceeds to block 408. At block 408, the UE transmits the packet to the RAN without performing an access control check (e.g., event 322). Otherwise, if the UE determines 1) the UE is not in SDT with the RAN and/or 2) the UE does not have a CG configuration for SDT (i.e., based on or in response to this determination), the flow proceeds to block 410. At block 410, the UE performs an access control check for the access attempt (e.g., event 314). At block 412, the UE determines whether the access control check indicates that the access attempt is allowed. If the UE determines the access barring check indicates that the access attempt is allowed (i.e., based on or in response to this determination), the flow proceeds to block 414. At block 414, the UE performs a random access procedure with the RAN. At block 416, the UE transmits the packet to the RAN in an uplink transmission in the random access procedure (e.g., event 316). Otherwise, if the UE determines the access barring check does not indicate that the access attempt is allowed (is barred) (i.e., based on or in response to this determination), the flow proceeds to block 418. At block 418, the UE refrains from transmitting the packet.

The blocks 406, 408, 410, 412, 414, 416 and 418 are collectively referred to in FIG. 4 as an SDT packet access control procedure 490.

In some implementations, the packet can be an Internet Protocol (IP) packet or an Ethernet packet. In other implementations, the packet can be a NAS message or an LTE Positioning Protocol (LPP) message. In some implementations, the UE at block 408 can transmit the packet to the RAN without performing a random access procedure. In one implementation, the UE receives a DCI and a CRC (of the DCI) scrambled with a C-RNTI on a PDCCH from the RAN. The UE transmits an uplink transmission including the packet in accordance with an uplink grant in the DCI. In such an example, the UE may not have a CG configuration for SDT. In another implementation, the UE can transmit an uplink transmission including the packet in accordance with the CG configuration without performing a random access procedure. The uplink transmission can be a PUSCH transmission, a HARQ transmission, or an uplink MAC PDU. In some implementations, the UE can include an uplink RRC message (e.g., RRC resume request message) in the uplink transmission.

In some implementations, the UE at block 414 performs the random access procedure with the RAN in order to transmit the packet. In the random access procedure, the UE transmits a random access preamble to the RAN, receives a random access response from the RAN in response to the random access preamble, transmits an uplink transmission including the packet to the RAN in accordance with an uplink grant received in the random access response, and receives from the RAN a downlink transmission including a contention resolution in response to the uplink transmission. The uplink transmission can be a PUSCH transmission, a HARQ transmission, or an uplink MAC PDU. The downlink transmission can be a PDSCH transmission, a HARQ transmission, or a downlink MAC PDU.

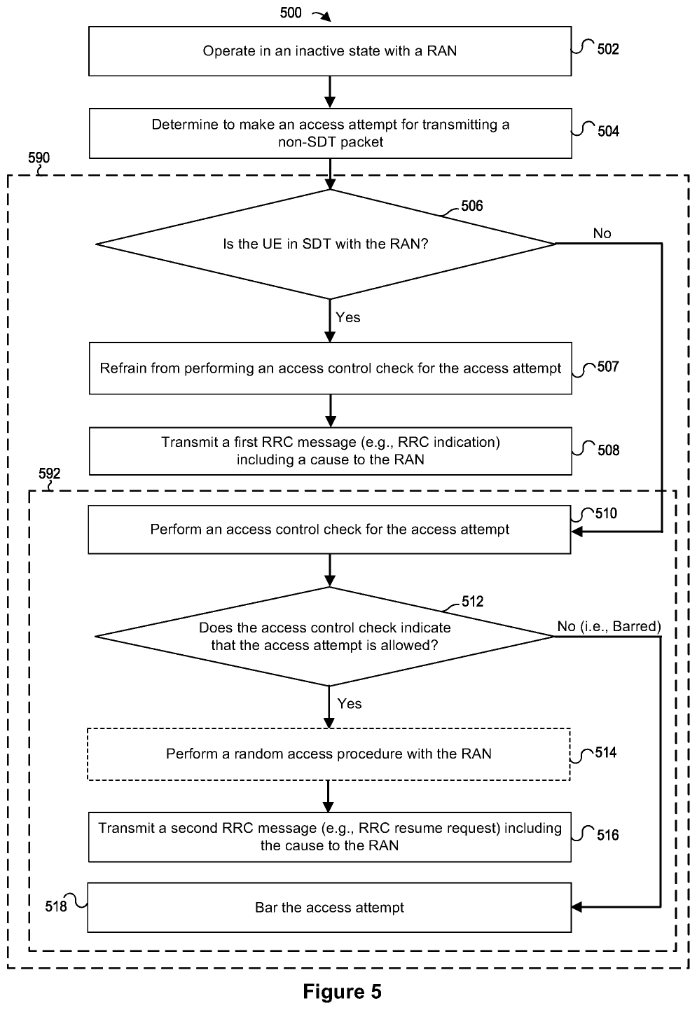

Turning to FIG. 5, a UE (e.g., the UE 102) can implement an example method 500 to determine whether to perform an access control check for an access attempt, while operating in the inactive state.

The method 500 begins at block 502, where the UE operates in an inactive state with a RAN (e.g., the RAN 105, base station 104/106, CU 172, CU-CP 172A) (e.g., event 308). At block 504, the UE determines to make an access attempt for transmitting a non-SDT packet (i.e., a packet does not qualify for SDT) (e.g., event 323). At block 506, the UE determines whether the UE is in SDT with the RAN (i.e., whether the UE has an SDT session with the RAN). If the UE determines the UE is in SDT with the RAN (i.e., based on or in response to this determination), the flow proceeds to block 507. At block 507, the UE refrains from performing an access control check for the access attempt. At block 508, the UE transmits a first RRC message including a cause to the RAN (e.g., an RRC indication message as at event 325). Otherwise, if the UE determines the UE is not in SDT with the RAN at block 506 (i.e., based on or in response to this determination), the flow proceeds to block 510. At block 510, the UE performs an access control check for the access attempt (e.g., event 314). At block 512, the UE determines whether the access control check indicates that the access attempt is allowed. If the UE determines the access control check indicates that the access attempt is allowed (i.e., based on or in response to this determination), the flow proceeds to block 514. At block 514, the UE can optionally perform a random access procedure with the RAN. At block 516, the UE transmits a second RRC message (e.g., an RRC resume request message) including the cause to the RAN. Otherwise, if the UE determines the access control check indicates that the access attempt is not allowed (i.e., barred) at block 512 (i.e., based on or in response to this determination), the flow proceeds to block 518. At block 518, the UE bars the access attempt (i.e., the UE refrains from performing a transmission for the access attempt). In some implementations, the UE can start a barring timer in response to barring the access attempt. While the barring timer is running, the UE 102 can bar an access attempt for non-SDT (similar to the access attempt of block 504), and/or can bar an access attempt for SDT. After the barring timer expires, the UE can perform another access control check for another access attempt.

The blocks 510, 512, 514, 516 (optional), and 518 are collectively referred to in FIG. 5 as a non-SDT packet access control without SDT procedure 592. The blocks 506, 507, 508, 510, 512, 514, 516 (optional), and 518 are collectively referred to in FIG. 5 as a non-SDT packet access control procedure 590.

In some implementations, the first RRC message can be a UL-DCCH-Message message. In such cases, the UL-DCCH-Message can include a UEAssistanceInformation message, and the UE can include the cause in the UEAssistanceInformation message, for example. In other implementations, the first RRC message can be a UL-CCCH-Message message. In such cases, the UL-CCCH-Message message can include an RRCResumeRequest message, and the UE can include the cause in the RRCResumeRequest message. In some implementations, the second RRC message can be a UL-CCCH-Message message. In such cases, the UL-CCCH-Message message can include an RRCResumeRequest message, and the UE can include the cause in the RRCResumeRequest message.

In some implementations, the UE determines an access category and/or an access identity associated with the access attempt, and performs the access barring check using the access category and/or access identity.

In some implementations, the UE transmits the first RRC message to the RAN without performing a random access procedure. In one implementation, the UE receives a DCI and a CRC (of the DCI) scrambled with a C-RNTI on a PDCCH from the RAN. The UE transmits an uplink transmission including the first RRC message in accordance with an uplink grant in the DCI. In another implementation, the UE can transmit an uplink transmission including the first RRC message in accordance with the configured grant configuration without performing a random access procedure. The uplink transmission can be a PUSCH transmission, a HARQ transmission or an uplink MAC PDU.

In some implementations, the UE performs the random access procedure with the RAN in order to transmit the second RRC message. In the random access procedure, the UE transmits a random access preamble to the RAN, receives a random access response from the RAN in response to the random access preamble, transmits an uplink transmission including the second RRC message to the RAN in accordance with an uplink grant received in the random access response, and receives from the RAN a downlink transmission including a contention resolution in response to the uplink transmission. The uplink transmission can be a PUSCH transmission, a HARQ transmission, or an uplink MAC PDU.

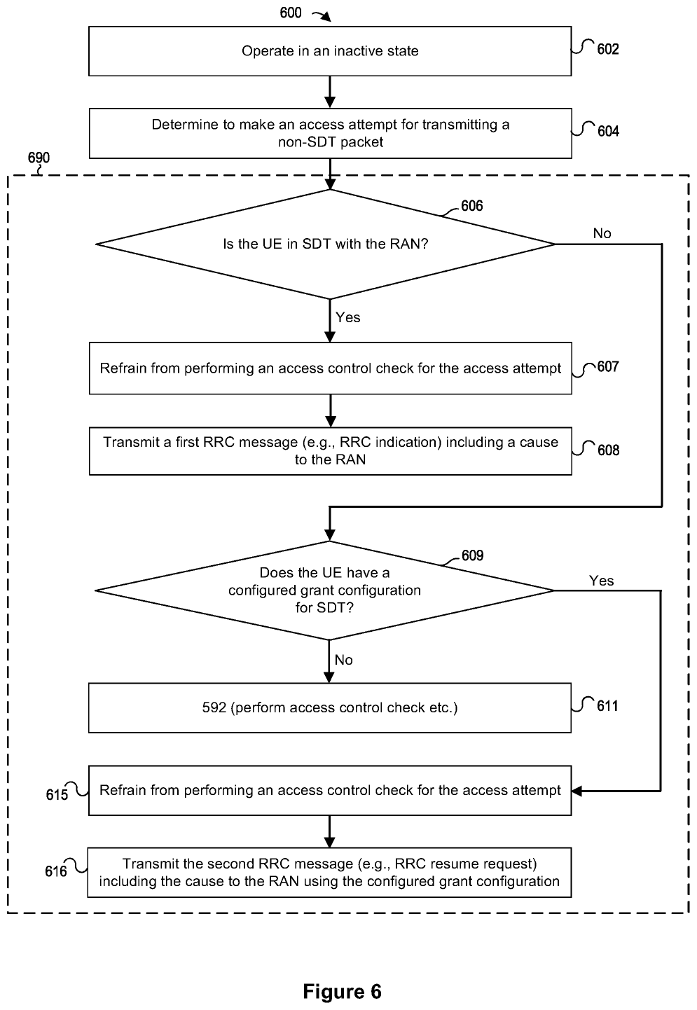

Turning to FIG. 6, a UE (e.g., the UE 102) can implement an example method 600 to determine whether to perform an access control check for an access attempt, while operating in the inactive state.

The method 600 begins at block 602, where the UE operates in an inactive state (e.g., event 308). At block 604, the UE determines to make an access attempt for transmitting a non-SDT packet (e.g., event 323). At block 606, the UE determines whether the UE is in SDT with the RAN. If the UE determines the UE is in SDT with the RAN (i.e., based on or in response to this determination), the flow proceeds to block 607. At block 607, the UE refrains from performing an access control check for the access attempt. At block 608, the UE transmits a first RRC message including a cause to the RAN (e.g., an RRC indication message as at event 325). Otherwise, if the UE determines the UE is not in SDT with the RAN at block 606 (i.e., based on or in response to this determination), the flow proceeds to block 609. At block 609, the UE determines whether the UE has a CG configuration for SDT. If the UE determines that the UE does not have a CG configuration for SDT (i.e., based on or in response to this determination), the flow proceeds to block 611. At block 611, the flow proceeds to a non-SDT packet access control without SDT procedure, similar to the procedure 592 of FIG. 5. Otherwise, if the UE determines the UE has a CG configuration for SDT at block 609 (i.e., based on or in response to this determination), the flow proceeds to block 615. At block 615, the UE refrains from performing an access control check for the access attempt. At block 616, the UE transmits a second RRC message (e.g., an RRC resume request message) including the cause to the RAN using the CG configuration.

The blocks 606, 607, 608, 611, 615, and 616 are collectively referred to in FIG. 6 as a non-SDT packet access control procedure 690.

In some implementations, the UE at block 616 can transmit an uplink transmission including the second RRC message in accordance with the CG configuration without performing a random access procedure.

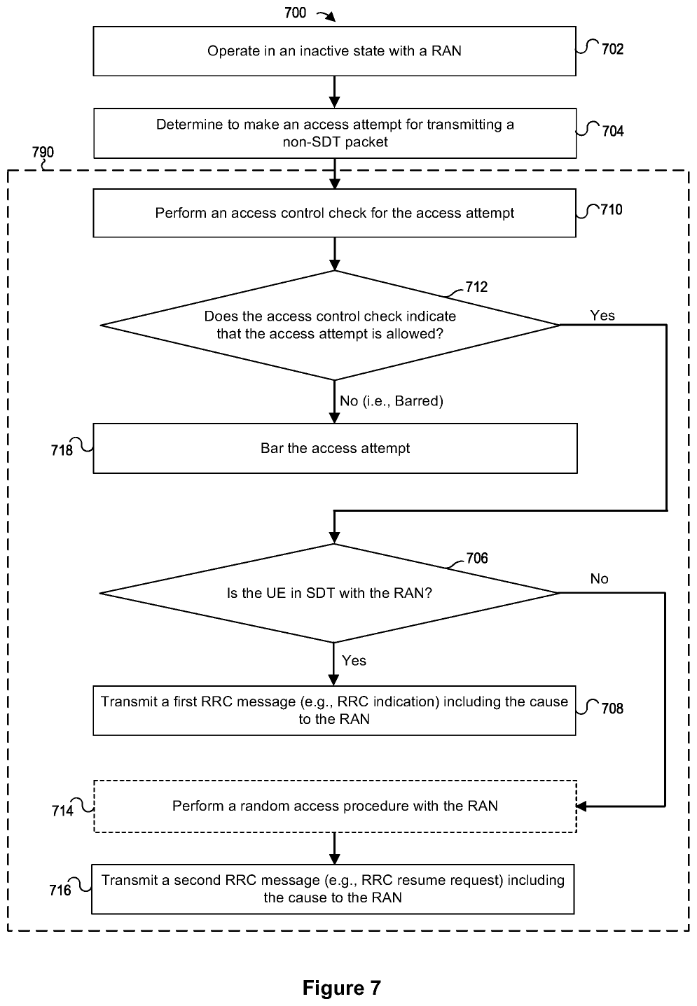

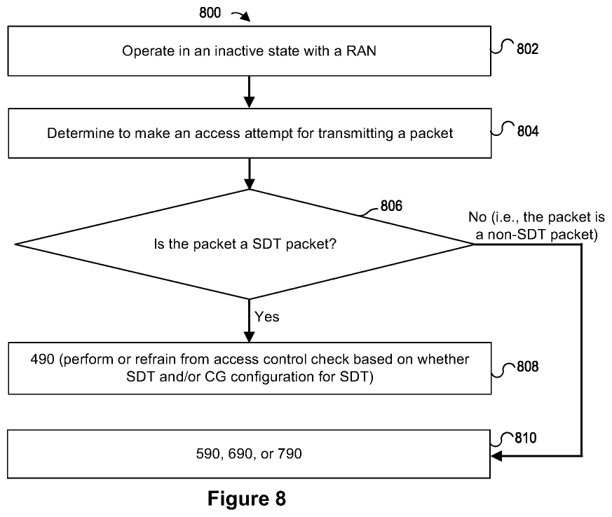

Turning to FIG. 7, a UE (e.g., the UE 102) can implement an example method 700 to determine whether to perform an access control check for an access attempt, while operating in the inactive state.

The method 700 begins at block 702, where the UE operates in an inactive state with a RAN (e.g., event 308). At block 704, the UE determines to make an access attempt for transmitting a non-SDT packet (i.e., a packet does not qualify for SDT) (e.g., event 323). At block 710, the UE performs an access control check for the access attempt. Thus, unlike the methods 400, 500, 600, the UE performs an access control check irrespective of whether the UE is in SDT with the RAN, and irrespective of whether the UE has a CG configuration for SDT or has started a SDT session. At block 712, the UE determines whether the access barring check indicates that the access attempt is allowed. If the UE determines that the access barring check indicates that the access attempt is barred (i.e., based on or in response to this determination), the flow proceeds to block 718. At block 718, the UE bars the access attempt (i.e., the UE refrains from performing a transmission for the access attempt). Otherwise, if the UE determines the access barring check indicates that the access attempt is allowed (i.e., based on or in response to this determination), the flow proceeds to block 706. At block 706, the UE determines whether the UE is in SDT with the RAN. If the UE determines the UE is in SDT with the RAN (i.e., based on or in response to this determination), the flow proceeds to block 708. At block 708, the UE transmits a first RRC message (e.g., an RRC indication message) including the cause to the RAN (e.g., event 325). Otherwise, if the UE determines the UE is not in SDT with the RAN (i.e., based on or in response to this determination), the flow proceeds to block 714. At block 714, the UE can optionally perform a random access procedure with the RAN. At block 716, the UE transmits a second RRC message (e.g., an RRC resume request message) including the cause to the RAN.

The blocks 710, 712, 718, 706, 708, 714, and 716 are collectively referred to in FIG. 7 as a non-SDT packet access control procedure 790. Examples and implementations for the method 500 can apply to the method 700.

Turning to FIG. 8, a UE (e.g., the UE 102) can implement an example method 800 to determine whether to perform an access control check for an access attempt, while operating in the inactive state.

The method 800 begins at block 802, where the UE operates in an inactive state with a RAN (see e.g., event 308). At block 804, the UE determines to make an access attempt to transmit a packet. At block 806, the UE determines whether the packet is an SDT packet. If the UE determines the packet is an SDT packet (i.e., based on or in response to this determination), the flow proceeds to block 808. At block 808, the flow proceeds to a SDT packet access control procedure as described for the procedure 490. Otherwise, if the UE determines that the packet is a non-SDT packet (i.e., based on or in response to this determination), the flow proceeds to block 810. At block 810, the flow proceeds to a non-SDT packet access control procedure as described for the procedure 590, 690, or 790, depending on the implementation.

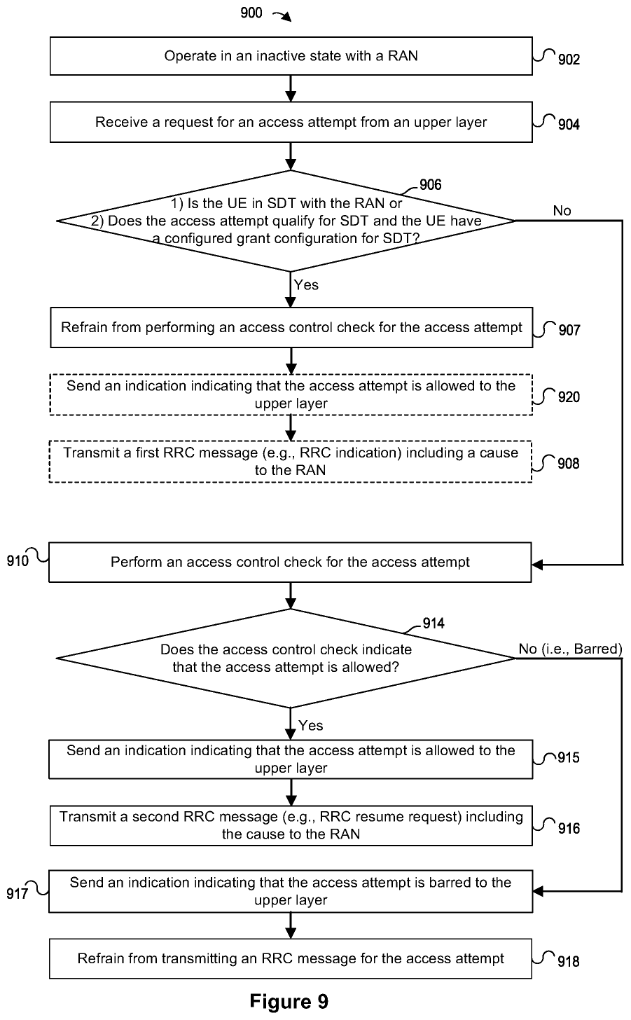

Turning to FIG. 9, an RRC layer (e.g., RRC layer 210 as implemented by RRC inactive controller 158) of a UE (e.g., the UE 102) can implement an example method 900 to determine whether to perform an access control check for an access attempt, while operating in the inactive state.

The method 900 begins at block 902, where the RRC layer operates in an inactive state with a RAN. At block 904, the RRC layer receives a request for an access attempt from an upper layer. At block 906, the RRC layer determines whether 1) the UE is in SDT with the RAN or 2) the access attempt qualifies for SDT and the UE has a configured grant configuration for SDT. If the RRC layer determines 1) the UE is in SDT with the RAN or 2) the access attempt qualifies for SDT and the UE has a configured grant configuration for SDT (i.e., based on or in response to this determination, and if either one or both conditions are satisfied), the flow proceeds to block 907. At block 907, the RRC layer refrains from performing an access barring check for the access attempt. At block 920, the RRC layer sends an indication indicating that the access attempt is allowed to the upper layer. At block 908, the RRC layer transmits a first RRC message including a cause to the RAN. Otherwise, if the RRC layer determines that neither condition 1) nor condition 2 are met at block 906 (i.e., based on or in response to this determination), the flow proceeds to block 910. At block 910, the RRC layer performs an access control check for the access attempt. At block 914, the RRC layer determines whether the access control check indicates that the access attempt is allowed. If the RRC layer determines the access control check indicates that the access attempt is allowed (i.e., based on or in response to this determination), the flow proceeds to block 915. At block 915, the RRC layer sends an indication indicating that the access attempt is allowed to the upper layer. At block 916, the RRC layer transmits a second RRC message including the cause to the RAN. Otherwise, if the RRC layer determines the access control check indicates that the access attempt is barred at block 914 (i.e., based on or in response to this determination), the flow proceeds to block 917. At block 917, the RRC layer sends an indication indicating that the access attempt is barred to the upper layer. At block 918, the RRC layer refrains from transmitting an RRC message for the access attempt.

In some implementations, the “upper layer” of FIG. 9 is a layer above the RRC layer. For example, the upper layer can be an MM layer (e.g., MM layer 214). In another example, the “upper layer” of FIG. 9 can be a data service layer which manage data service initiation or transmission. In some implementations, examples or implementations described for the method 500 can apply to the method 900.

In some implementations, the RRC layer can receive an access category and/or an access identity for the access attempt from the upper layer. The UE at block 907 ignores or discards the access category and/or access identity. The UE at block 910 performs the access barring check using the access category and/or access identity. In some implementations, the upper layer sends the access category and/or access identity together with the request to the RRC layer. In one implementation, the upper layer sends the cause to the RRC layer after receiving the indication of block 709 or 715. In another implementation, the upper layer sends the cause to the RRC layer together with the request for the access attempt.

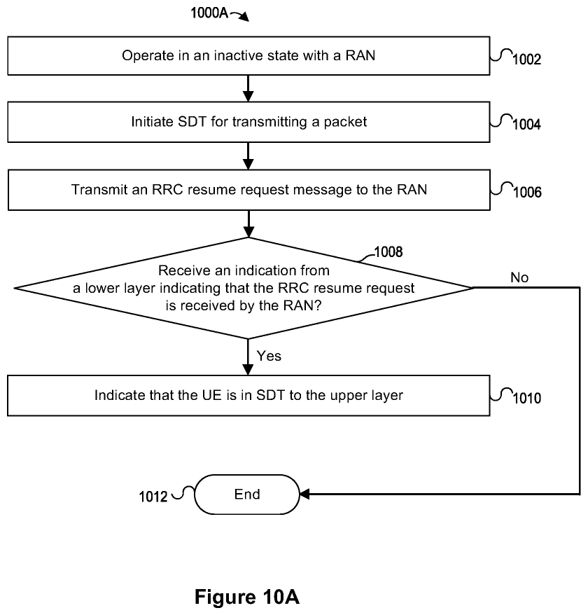

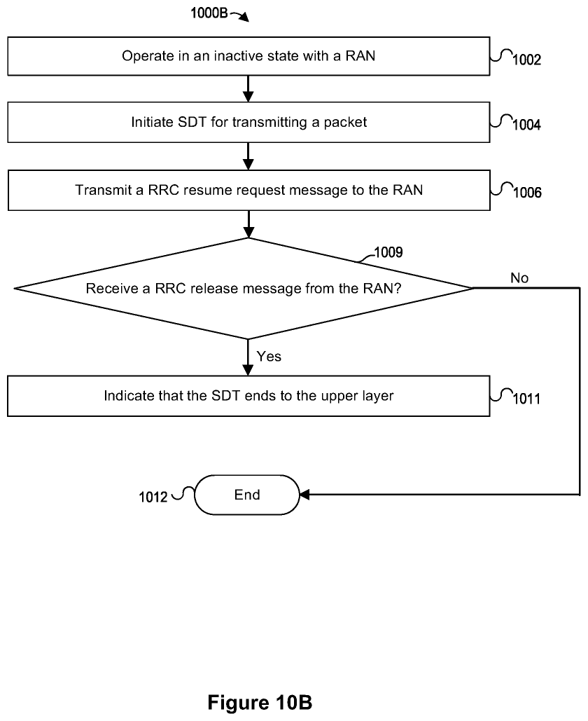

Turning to FIG. 10A, a RRC layer (e.g., RRC layer 210 as implemented by RRC inactive controller 158) of a UE (e.g., the UE 102) can implement an example method 1000A to determine whether to indicate that the UE is in SDT to an upper layer (e.g., MM layer such as MM layer 214), while operating in the inactive state.

The method 1000A begins at block 1002, where the RRC layer operates in an inactive state with a RAN (e.g., event 308). At block 1004, the RRC layer initiates SDT for transmitting a packet (e.g., event 312). At block 1006, the RRC layer transmits an RRC resume request message to the RAN (e.g., event 318). At block 1008, the RRC layer determines whether the RRC layer receives from a lower layer (e.g., MAC layer) an indication indicating that the RRC resume request message is received by the RAN (e.g., if the UE determines that the RAN received the RRC resume request message in the manner discussed above in connection with event 318). If the RRC layer receives the indication (i.e., based on or in response to this determination), the flow proceeds to block 1010. At block 1010, the RRC layer sends an indication that the UE is in SDT to an upper layer. Otherwise, if the RRC layer does not receive the indication (i.e., based on or in response to this determination), the flow proceeds to block 1012, where, the flow ends.

Turning to FIG. 10B, an RRC layer (e.g., RRC layer 210 as implemented by RRC inactive controller 158) of a UE (e.g., the UE 102) can implement an example method 1000B to determine whether to indicate that the SDT ends to an upper layer (e.g., an MM layer such as MM layer 214), while operating in the inactive state.

The method 1000B begins at block 1002, where the RRC layer operates in an inactive state with a RAN (e.g., event 308). At block 1004, the RRC layer initiates SDT for transmitting a packet (e.g., event 312). At block 1006, the RRC layer transmits an RRC resume request message to the RAN (see e.g., event 318). At block 1009, the RRC layer determines whether the RRC layer receives an RRC release message from the RAN in response to or after transmitting the RRC resume request message. If the RRC layer receives the RRC release message from the RAN (i.e., based on or in response to this determination), the flow proceeds to block 1011. At block 1011, the RRC layer sends an indication that the SDT ends to an upper layer. Otherwise, if the RRC layer does not receive the RRC release message from the RAN (i.e., based on or in response to this determination), the flow proceeds to at block 1012, where the flow ends.

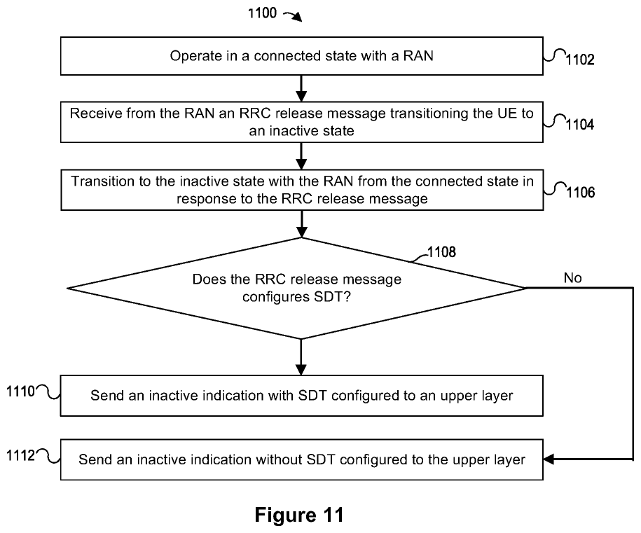

Turning to FIG. 11, a RRC layer (e.g., RRC layer 210 as implemented by RRC inactive controller 158) of a UE (e.g., the UE 102) can implement an example method 1100 to determine whether to send an inactive indication with or without SDT configured to an upper layer (e.g., MM layer such as MM layer 214), while operating in the inactive state.

The method 1100 begins at block 1102, where the RRC layer operates in a connected state with a RAN. At block 1104, the RRC layer receives from the RAN a RRC release message transitioning the UE to an inactive state. At block 1106, the RRC layer transitions to the inactive state with the RAN from the connected state in response to the RRC release message. At block 1108, the RRC layer determines whether the RRC release message configures SDT. If the RRC layer determines that the RRC release message configures SDT (i.e., based on or in response to this determination), the flow proceeds to block 1110. At block 1110, the RRC layer sends an inactive indication with SDT configured to an upper layer. Otherwise, if the RRC layer determines that the RRC release message does not configure SDT (i.e., based on or in response to this determination), the flow proceeds to block 1112. At block 1112, the RRC layer sends an inactive indication without SDT configured to the upper layer.

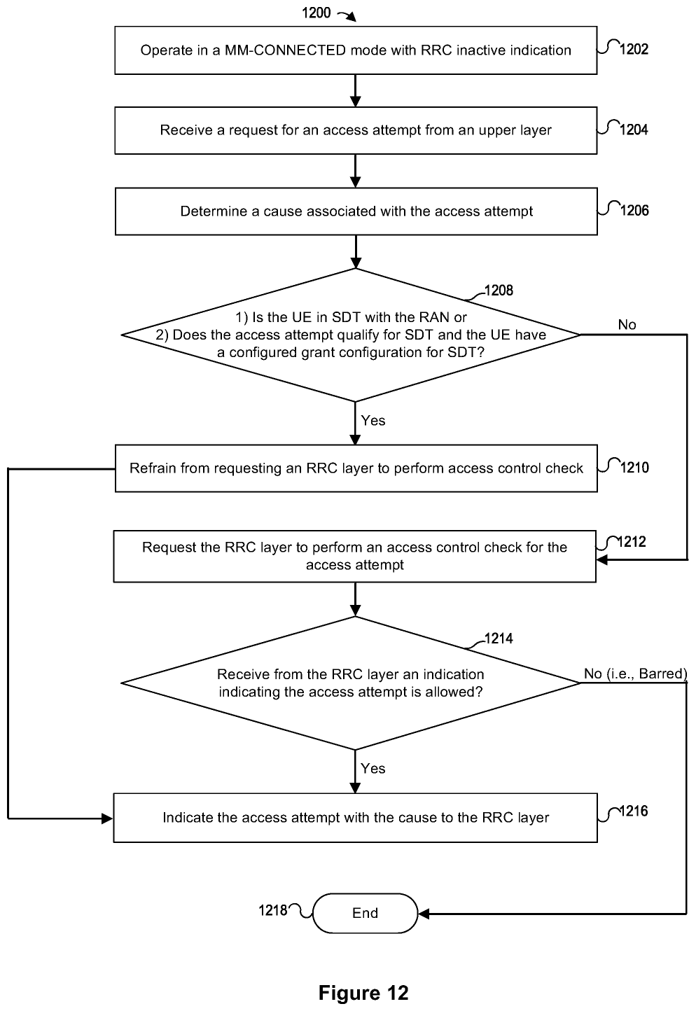

Turning to FIG. 12, an MM layer (e.g., MM layer 214 as implemented by upper layer controller 157) of a UE (e.g., the UE 102) can implement an example method 1200 to determine whether to request an RRC layer (e.g., RRC layer 210 as implemented by RRC inactive controller 158) to perform an access control check for an access attempt.

The method 1200 begins at block 1202, where the MM layer operates in an MM-CONNECTED mode with RRC inactive indication. At block 1204, the MM layer receives a request for an access attempt from an upper layer. At block 1206, the MM layer determines a cause associated with the access attempt. At block 1208, the MM layer determines whether 1) the UE is in SDT with the RAN or 2) the access attempt qualifies for SDT and the UE has a configured grant configuration for SDT. If the MM layer determines 1) the UE is in SDT with the RAN or 2) the access attempt qualifies for SDT and the UE has a configured grant configuration for SDT (i.e., based on or in response to this determination, and if either one or both conditions are satisfied), the flow proceeds to block 1210. At block 1210, the MM layer refrains from requesting a RRC layer to perform access barring check. Otherwise, if the MM layer determines that neither condition 1) nor 2) is met (i.e., based on or in response to this determination), the flow proceeds to block 1212. At block 1212, the MM layer requests the RRC layer to perform an access barring check for the access attempt. At block 1214, the MM layer determines whether that MM layer receives from the RRC layer an indication indicating that the access attempt is allowed. If the MM layer receives from the RRC layer an indication indicating that the access attempt is allowed (i.e., based on or in response to this determination), the flow proceeds to block 1216. At block 1216, the MM layer sends an indication indicating that the access attempt with the cause to the RRC layer. Otherwise, if the MM layer receives from the RRC layer an indication indicating the access attempt is barred (i.e., based on or in response to this determination), the flow proceeds to block 1218, where the flow ends.

In some implementations of the method 1200, the upper layer (e.g., MM layer) determines an access category and/or an access identity associated with the access attempt. In such implementations, the upper layer can request that the RRC layer perform the access control check for the access attempt in accordance with the access category and/or access identity.

In some implementations and/or scenarios, the upper layer (e.g., MM layer) can indicate the access attempt for SDT to the RRC layer. In other implementations and/or scenarios, the upper layer can indicate the access attempt for non-SDT to the RRC layer.

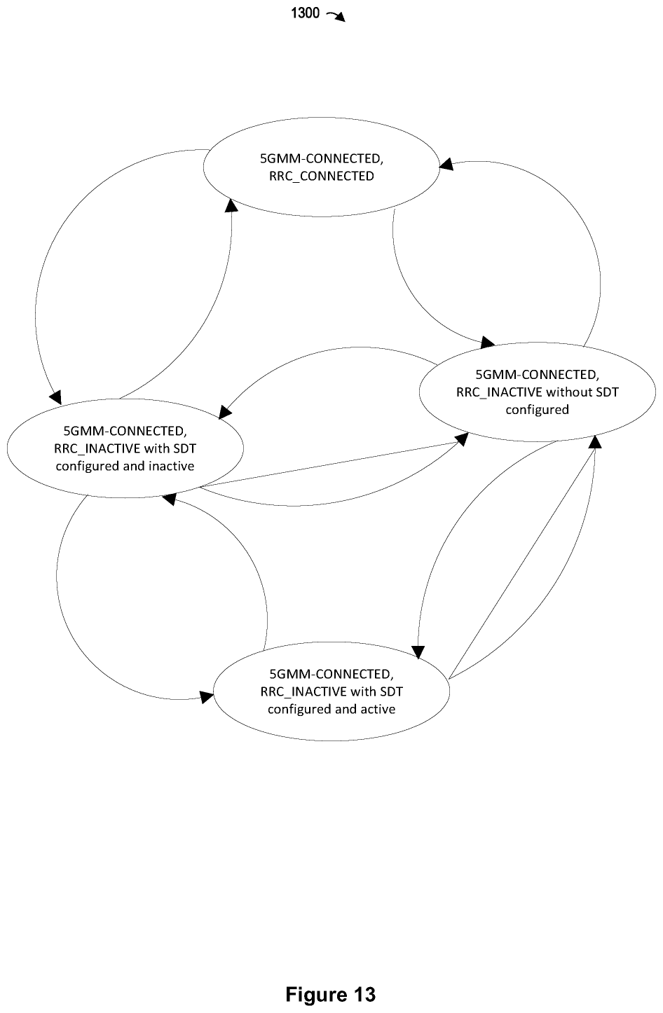

Turning to FIG. 13, a state transition diagram 1300 depicts MM state transitions between different states operated by an MM layer (e.g., MM layer 214 as implemented by upper layer controller 157) of a UE (e.g., UE 102), while the MM layer operates in a 5GMM-CONNECTED state. If the MM layer receives from an RRC layer an indication indicating the RRC_CONNECTED state, the MM layer operates in the 5GMM-CONNECTED state with the RRC_CONNECTED state. If the MM layer receives from the RRC layer an indication indicating the RRC_INACTIVE state without SDT configured, the MM layer operates in the 5GMM-CONNECTED state with the RRC_INACTIVE state without SDT configured. If the MM layer receives from the RRC layer an indication indicating RRC_INACTIVE state with SDT configured, the MM layer operates in the 5GMM-CONNECTED state with the RRC_INACTIVE state with SDT configured. If the MM layer receives from the RRC layer an indication indicating RRC_INACTIVE state with SDT configured and active (i.e., the UE has an SDT session with a RAN), the MM layer operates in the 5GMM-CONNECTED state with the RRC_INACTIVE state with SDT configured and active.

The following list of examples reflects a variety of the implementations explicitly contemplated by the present disclosure:

Example 1. A method, implemented by a user equipment (UE), of managing access control procedures for accessing a radio access network (RAN), the method comprising: initiating, by processing hardware of the UE and while the UE is in an inactive state, small data transmission (SDT) with the RAN; disabling, by the processing hardware, an access control check function of the UE for at least a portion of a time that the UE is in SDT with the RAN; and while the UE is in SDT with the RAN and the access control check function is disabled, transmitting, by the processing hardware, uplink data to the RAN.

Example 2. The method of example 1, further comprising: determining, by the processing hardware, to make an access attempt for transmitting an SDT packet, wherein the disabling is in response to at least one of (i) the UE being in SDT with the RAN or (ii) the UE having a configured grant configuration for SDT, and wherein transmitting the uplink data includes transmitting the SDT packet.

Example 3. The method of example 1, wherein: the method further comprises receiving, by processing hardware of the UE and at a radio resource control (RRC) layer from an upper layer, a request for an access attempt for accessing the RAN; the disabling is in response to at least one of (i) the UE being in small data transmission (SDT) with the RAN or (ii) the UE having a configured grant configuration for SDT; and the method further comprises sending to the upper layer, by the processing hardware and from the RRC layer, an indication indicating that the access attempt is allowed.

Example 4. The method of example 1, further comprising: receiving, by the processing hardware and by a mobility management (MM) layer, a request for an access attempt from an upper layer above the MM layer; and sending, by the processing hardware and from the MM layer, an indication indicating the access attempt to a radio resource control (RRC) layer, wherein the disabling is in response to at least one of (i) the UE being in SDT with the RAN or (ii) the access attempt qualifying for SDT and the UE having a configured grant configuration for SDT.

Example 5. The method of example 4, further comprising: determining, by the processing hardware and at the MM layer, a cause associated with the access attempt, wherein the indication indicates the access attempt and the cause to the RRC layer.

Example 6. The method of example 1, further comprising, after the initiating and before the disabling: performing, by the processing hardware, an access control check; determining, by the processing hardware and based on the access control check, that an access attempt is allowed; and based on the determining, transmitting, by the processing hardware, other uplink data to the RAN.

Example 7. The method of example 1, further comprising: determining, by the processing hardware, to make an access attempt for transmitting a non-SDT packet; and in response to the UE having a configured grant configuration for SDT, (i) refraining, by the processing hardware, from performing an access control check for the non-SDT packet, and (ii) transmitting a radio resource control (RRC) message to the RAN, the RRC message including a cause of the access attempt.

Example 8. The method of example 1, further comprising: determining, by the processing hardware, to make an access attempt for transmitting a non-SDT packet; and performing, by the processing hardware, an access control check for the access attempt.

Example 9. The method of example 8, further comprising: determining, by the processing hardware and based on the access control check, that the access attempt is allowed; and based on the determining that the access attempt is allowed, transmitting a radio resource control (RRC) message to the RAN, the RRC message including a cause of the access attempt.

Example 10. The method of example 1, further comprising: determining, by the processing hardware and while the UE is in the inactive state, to make an access attempt for transmitting a packet; determining, by the processing hardware, whether the packet is an SDT packet or a non-SDT packet, wherein the disabling is based in part on the determining that the packet is an SDT packet.

Example 11. The method of example 10, comprising determining that the packet is an SDT packet, and wherein: the disabling is in response to at least one of (i) the UE being in SDT with the RAN or (ii) the UE having a configured grant configuration for SDT; and transmitting the uplink data includes transmitting the SDT packet.

Example 12. The method of example 10, wherein: the method comprises determining that the packet is a non-SDT packet; and the method further comprises, in response to the UE having a configured grant configuration for SDT, (i) refraining, by the processing hardware, from performing an access control check for the non-SDT packet, and (ii) transmitting a radio resource control (RRC) message to the RAN, the RRC message including a cause of the access attempt.

Example 13. The method of example 10, wherein: the method comprises determining that the packet is a non-SDT packet; and the method further comprises performing, by the processing hardware, an access control check.

Example 14. The method of example 13, further comprising: determining, by the processing hardware and based on the access control check, that an access attempt is allowed; and based on the determining that the access attempt is allowed, transmitting a radio resource control (RRC) message to the RAN, the RRC message including a cause of the access attempt.

Example 15. The method of example 1, further comprising: after the initiating, transmitting, by the processing hardware, a radio resource control (RRC) resume request message to the RAN; receiving from a lower layer, by the processing hardware and at an RRC layer, a first indication indicating that the RRC resume request message was received by the RAN; and in response to receiving the first indication, sending to an upper layer, by the processing hardware and from the RRC layer, a second indication indicating that the UE is in SDT.

Example 16. The method of example 1, further comprising: after the initiating, transmitting, by the processing hardware, a radio resource control (RRC) resume request message to the RAN; receiving from the RAN, by the processing hardware, an RRC release message; and in response to receiving the RRC release message, sending to an upper layer, by the processing hardware and from an RRC layer, an indication indicating that SDT ends.

Example 17. The method of example 1, further comprising: determining, by the processing hardware, to make an access attempt for transmitting a non-SDT packet; performing, by the processing hardware, an access control check for the access attempt; determining, by the processing hardware and based on the access control check, that the access attempt is barred; and starting, by the processing hardware, a barring timer that bars access attempts for SDT and non-SDT communications until expiration of the barring timer.

Example 18. The method of example 1, further comprising: determining, by the processing hardware, to make an access attempt for transmitting a non-SDT packet; determining, by the processing hardware and by an upper layer above a radio resource control (RRC) layer, an access category and/or an access identity associated with the access attempt; and requesting, by the processing hardware and by the upper layer, that the RRC layer perform an access control check in accordance with the access category and/or access identity.

Example 19. The method of example 18, wherein the upper layer is a mobility management layer.

Example 20.A method, implemented by a user equipment (UE), of managing access control procedures for accessing a radio access network (RAN), the method comprising: receiving, by processing hardware of the UE, a radio resource control (RRC) release message from the RAN; in response to the RRC release message, transitioning, by the processing hardware, from a connected state to an inactive state; and sending to an upper layer, by the processing hardware and from an RRC layer, either a first indication when the RRC release message configures SDT for the UE or a second indication when the RRC release message does not configure SDT for the UE, wherein the first indication indicates that the UE is inactive with SDT configured, and wherein the second indication indicates that the UE is inactive without SDT configured.

Example 21. The method of example 20, wherein the upper layer is a mobility management layer.

Example 22. A user equipment (UE) comprising hardware and configured to perform the method of any one of examples 1-21.

The following description may be applied to the description above.

In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “communicating data via RB(s)” can be replaced by “communicate data associated to RB(s)” or “communicate data on RB(s),” and “communicate” can be replaced by “transmit,” “receive,” or “transmit and receive”. In some implementations, the CU-to-DU message(s) and CU-to-DU message(s) can be F1 application protocol (F1AP) message(s), e.g., as defined in 3GPP specification 38.473. In some implementations, the CU-to-DU message(s) and CU-to-DU message(s) can be UE-associated message(s) or non-UE-associated message(s). For example, the CU-to-DU message(s) and CU-to-DU message(s) can be UE-associated message(s) in the case of “unicast”, and the CU-to-DU message(s) and CU-to-DU message(s) can be non-UE-associated message(s) in the case of “broadcast”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, performed by a user equipment (UE), of managing access control procedures for accessing a radio access network (RAN) during small data transmission (SDT) with the RAN, the method comprising:
operating in an inactive state with the RAN;
determining to make an access attempt for transmitting a packet;
when the UE is in SDT with the RAN and the packet is a non-SDT packet,
performing an access control check for the access attempt, and
either barring the access attempt when the access control check does not indicate that the access attempt is allowed, or transmitting a first radio resource control (RRC) message to the RAN when the access control check indicates that the access attempt is allowed; and
when the UE is in SDT with the RAN and the packet is an SDT packet,
transmitting the SDT packet to the RAN without performing an access control check for the access attempt.

2. The method of claim 1, wherein the first RRC message includes a cause of the access attempt.

3. The method of claim 1, wherein the first RRC message is an RRC indication message indicating that non-SDT data is available.

4. The method of claim 1, wherein, when the UE is not in SDT with the RAN, the method includes:
performing an access control check for the access attempt, and
either barring the access attempt when the access control check does not indicate that the access attempt is allowed, or transmitting a second RRC message to the RAN when the access control check indicates that the access attempt is allowed.

5. The method of claim 4, wherein the second RRC message includes a cause of the access attempt.

6. The method of claim 4, wherein the second RRC message is an RRC resume request message.

7. The method of claim 4, wherein, when the UE is not in SDT with the RAN, the method includes:
performing the access control check for the access attempt, and
either barring the access attempt when the access control check does not indicate that the access attempt is allowed, or (i) performing a random access procedure with the RAN, and (ii) transmitting the second RRC message to the RAN, when the access control check indicates that the access attempt is allowed.

8. A method, performed by a user equipment (UE), of managing access control procedures for accessing a radio access network (RAN), the method comprising:
receiving a radio resource control (RRC) release message from the RAN;
in response to the RRC release message, transitioning from a connected state to an inactive state; and
sending to an upper layer, from an RRC layer, either a first indication when the RRC release message configures SDT for the UE or a second indication when the RRC release message does not configure SDT for the UE,
wherein the first indication indicates that the UE is inactive with SDT configured, and
wherein the second indication indicates that the UE is inactive without SDT configured.

9. The method of claim 8, wherein the upper layer is a mobility management layer.

10. A user equipment (UE) comprising hardware and configured to:
operate in an inactive state with a radio access network (RAN);
determine to make an access attempt for transmitting a packet;
when the UE is in small data transmission (SDT) with the RAN and the packet is a non-SDT packet,
perform an access control check for the access attempt, and
either bar the access attempt when the access control check does not indicate that the access attempt is allowed, or transmit a first radio resource control (RRC) message to the RAN when the access control check indicates that the access attempt is allowed; and
when the UE is in SDT with the RAN and the packet is an SDT packet,
transmit the SDT packet to the RAN without performing an access control check for the access attempt.

11. The UE of claim 10, wherein the first RRC message includes a cause of the access attempt.

12. The UE of claim 10, wherein the first RRC message is an RRC indication message indicating that non-SDT data is available.

13. The UE of claim 10, wherein, when the UE is not in SDT with the RAN, the UE is configured to:
perform an access control check for the access attempt, and
either bar the access attempt when the access control check does not indicate that the access attempt is allowed, or transmit a second RRC message to the RAN when the access control check indicates that the access attempt is allowed.

14. The UE of claim 13, wherein the second RRC message includes a cause of the access attempt.

15. The UE of claim 13, wherein the second RRC message is an RRC resume request message.

16. The UE of claim 13, wherein, when the UE is not in SDT with the RAN, the UE is configured to:
perform the access control check for the access attempt, and
either bar the access attempt when the access control check does not indicate that the access attempt is allowed, or (i) perform a random access procedure with the RAN, and (ii) transmit the second RRC message to the RAN, when the access control check indicates that the access attempt is allowed.
